(19) United States
(12) Patent Application Publication
(10) Pub. No.: US 2001/0056374 A1
(43) Pub. Date: Dec. 27, 2001

(54) Apparatus and method for providing compensation for advertisement viewing and/or participation and/or for survey participation

(76) Inventor: Raymond Anthony Joao, Yonkers, NY (US)

Correspondence Address: RAYMOND A. JOAO, ESQ., 122 BELLEVUE PLACE, YONKERS, NY, 10703, US

(21) Appl. No.: 09/886,228

(22) Filed: Jun. 21, 2001

Related U.S. Application Data
(60) Provisional application No. 60/213,331, filed on Jun. 22, 2000.

(51) Int. Cl. G06F 17/60

(52) U.S. Cl. 705/14

(57) ABSTRACT

An apparatus for providing compensation for viewing and/or for participating in an advertisement, a survey, a poll, or a questionnaire, including a receiver for receiving a request to obtain information regarding at least one of a good, a product, and a service, a memory device for storing information regarding at least one of the at least one of a good, a product, and a service, advertisement information, survey information, polling information, or questionnaire information, and at least one advertisement, survey, poll, or questionnaire, a processor for processing the request to receive information regarding the at least one of a good, a product, and a service, wherein the processor at least one of identifies and selects an advertisement, a survey, a poll, or a questionnaire, to provide to the information requesting individual upon the information requesting individual placing an order to at least one of purchase and lease at least one of a good, a product, and a service, and a transmitter for transmitting the advertisement, the survey, the poll, or the questionnaire, to a communication device associated with the information requesting individual. The processor at least one of monitors the requesting individual's at least one of viewing and participation in the advertisement, the survey, the poll, or the questionnaire. The processor determines an amount of at least one of a compensation, a reward, a rebate, and an incentive, earned by the information requesting individual. The processor at least one of adjusts and reduces the at least one of a purchase price and a lease price associated with the order by at least a portion of the amount of the at least one of a compensation, a reward, a rebate, and an incentive.

### RELATED APPLICATIONS

This application claims the benefit of priority of U.S. Provisional Patent Application Ser. No. 60/213,331, filed Jun. 22, 2000, and entitled “APPARATUS AND METHOD FOR PROVIDING COMPENSATION FOR ADVERTISMENT VIEWING AND/OR PARTICIPATION AND/OR FOR SURVEY PARTICIPATION”, the subject matter of which is hereby incorporated by reference herein.

### FIELD OF THE INVENTION

The present invention pertains to an apparatus and method for providing compensation for advertisement viewing and/or participation and/or for survey participation and, in particular, to an apparatus and method for providing compensation to individuals or entities who or which view, review, and/or participate in and/or interact with, advertisements, and/or for providing compensation to individuals or entities who or which view, review, and/or participate in and/or interact with, surveys, polls, questionnaires, and/or other information gathering efforts and/or activities.

### BACKGROUND OF THE INVENTION

Advertising and information gathering services play a crucial role in commerce. Providers of goods, products, and/or services, spend very large amounts of money and effort in order to advertise their respective goods, products, and/or services. Similarly, very large amounts of money and effort are expended, by the respective information gathering individuals and/or entities, in conducting surveys, taking polls, and/or in disseminating questionnaires.

Advertising budgets and budgets for conducting surveys, polls, and/or questionnaires, in the aggregate, can easily account for the spending of hundreds of millions of dollars, if not billions of dollars, annually. Perhaps one of the key concerns in conducting advertising campaigns, and/or in conducting surveys, polls, and/or questionnaires, is to secure the attention of the advertising audience and/or the survey, polling, and/or questionnaire audience.

The ever-growing use and popularity of the Internet and/or the World Wide Web has attracted many advertisers to reach out to the many individuals who use the Internet and/or the World Wide Web, and/or to those individuals who “surf the net” or “surf the Web”.

While the basic notion of compensating individuals for viewing advertisements has been introduced, current practices fall far too short of realizing the true potential of utilizing the Internet, the World Wide Web, and/or any other communication network, in providing compensation, rewards, rebates, and/or incentives, to individuals or entities for viewing, participating in, and/or interacting with, advertisements, surveys, polls, and/or questionnaires.

### SUMMARY OF THE INVENTION

The present invention pertains to an apparatus and method for providing compensation for advertisement viewing and/or participation and/or for survey participation which overcomes the shortcomings of the prior art. The present invention pertains to an apparatus and method for providing compensation for advertisement viewing and/or participation and/or for survey participation and, in particular, to an apparatus and method for providing compensation to individuals or entities who or which view, review, and/or participate in and/or interact with, advertisements, and/or for providing compensation to individuals or entities who or which view, review, and/or participate in and/or interact with, surveys, polls, questionnaires, and/or other information gathering efforts and/or activities.

The apparatus and method of the present invention also pertains to an apparatus and method for providing compensation-based advertising commerce and, in particular, to an apparatus and method for providing compensation to a buyer of goods and/or services and/or to a seller of goods and/or services so as to provide compensation, a reward, a rebate, and/or an incentive, to facilitating commerce between parties.

The apparatus and method of the present invention provides compensation-based advertising to a respective party, and/or to any number of parties, to, or involving, a potential transaction. A respective party or parties can receive compensation, a reward, a rebate, and/or an incentive, which can be utilized to facilitate commerce between any parties and/or any number of parties.

In the case of a buyer(s) of goods and/or services, a buyer(s) can view and/or participate in an advertisement for any good, product, and/or service, receive compensation, a reward, a rebate, and/or an incentive, which can be utilized by and/or applied towards a respective transaction in order to lower the price which the buyer will pay for the goods, products, and/or services. In this manner, a buyer or buyers can utilize and/or apply the respective compensation, reward, rebate, and/or incentive, to a respective transaction involving any goods, products, and/or services, in order to obtain the respective goods, products, and/or services, at a lower price or cost.

The apparatus and method of the present invention allows an individual or entity to earn compensation, rewards, rebates, and/or incentives, for viewing, reviewing, participating in and/or interacting with, advertisements and/or advertisement material. The compensation, rewards, rebates, and/or incentives, can be used by the individual or entity to lower a purchase price, a lease price. The compensation, rewards, rebates, and/or incentives, can also be utilized at any time, in a concurrent manner, in an immediate manner, in a deferred manner, and/or can be transferred to a third party.

In the case of a seller(s) of goods and/or services, a seller can view and/or participate in an advertisement for any good, product, and/or service, receive compensation, a reward, a rebate, and/or an incentive, which can be utilized by and/or applied towards lowering the selling price of the goods and/or services offered for sale by the seller. In this manner, a seller or sellers can utilize and/or apply the respective compensation, reward, rebate, and/or incentive, to a respective transaction involving any goods, products, and/or services, in order to obtain to lower the selling price of the respective goods, products, and/or services.

The apparatus and method of the present invention allows a provider or seller of goods, products, and/or services, to earn compensation, rewards, rebates, and/or incentives, for viewing, reviewing, participating in and/or interacting with, advertisements and/or advertisement material. The compensation, rewards, rebates, and/or incentives, can be used by the provider or seller to lower a selling price or a leasing price. The compensation, rewards, rebates, and/or incentives, can also be utilized at any time, in a concurrent manner, in an immediate manner, in a deferred manner, and/or can be transferred to a third party.

In the case of buyers and sellers both utilizing the apparatus and method of the present invention in a same transaction, both the buyer(s) and seller(s) can obtain compensation, a reward, a rebate, and/or an incentive, from viewing and/or participating in respective advertisements, thereby resulting in compensation, rewards, rebates, and/or incentives flowing to both parties to a transaction and, therefore, enhanced savings for buyers and enhanced profits for sellers.

The advertising or advertisements can take any form and can include, but not be limited to, text advertisements, text/graphics advertisements, video advertisements, audio advertisements, audio-video advertisements, graphical advertisements such as buttons, banners, and the like. The advertisements can also be infomercials and/or any other multimedia advertisement.

The present invention can also provide compensation, rewards, rebates, and/or incentives, for and/or in conjunction with surveys, marketing surveys, market research surveys, questionnaires, marketing questionnaires, market research questionnaires, etc., which can be utilized instead of advertisements, and/or in addition to advertisements, in any and/or all of the embodiments described herein.

The apparatus and method of the present invention can be utilized to disseminate advertisements and/or to compensate and/or reward individuals and/or parties for viewing and/or participating in these advertisements. In this manner, advertisers can get their massage across to interested individuals and/or parties and/or compensate individuals and/or parties for their attention, time, and/or participation.

In the case of surveys and/or questionnaires, the party conducting the survey of circulating or providing the questionnaire can obtain the desired information while the individuals and/or parties who or which respond to the surveys or questionnaire can be compensated for the information they provided and/or for their time and efforts in responding to same.

The apparatus includes a central processing computer or server computer which can provide control over the apparatus and provides services for the various computers associated with the various individuals, users, clients, providers, advertisers and/or information gathering parties, who or which utilize the present invention.

The apparatus can also include any number of user Computers which can allow an individual or user to interact with the central processing computer(s) and/or with any of the other computers and/or communication devices described herein. The apparatus can also include one or more provider computers which allow a provider to interact with the central processing computer(s) and/or with any of the other computers and/or communication devices described herein.

The apparatus can also include one or more advertiser computers which allow an advertiser to interact with the central processing computer(s) and/or with any of the other computers and/or communication devices described herein. The apparatus can also include one or more information gathering entity computers which allow an information gathering entity to interact with the central processing computer(s) and/or with any of the other computers and/or communication devices described herein.

Any of the central processing computers, the user computers, the provider computers, the advertiser computers, and the information gathering entity computers can transmit information to and receive information from any of the central processing computers, the user computers, the provider computers, the advertiser computers, and the information gathering entity computers, described herein and/or can transmit information to and receive information from any of the other central processing computers, the user computers, the provider computers, the advertiser computers, and the information gathering entity computers described herein.

Each of the central processing computers, the user computers, the provider computers, the advertiser computers, and the information gathering entity computers can be wireless communication devices, and/or can be computers or other processing devices and/or communication devices which can operate in a wireless communication environment, in a wired or line-connected environment, and/or in an combination and/or hybrid environment(s).

The central processing computers, the user computers, the provider computers, the advertiser computers, and the information gathering entity computers, can communicate with one another, and/or be linked to one another, over a communication network and/or a wireless communication network. The present invention is utilized on, and/or over, the Internet and/or the World Wide Web. The present invention can also utilize wireless Internet and/or World Wide Web services, equipment and/or devices.

The central processing computer(s) can have a respective web site, web sites, web page, and/or web pages, associated therewith. Any of the user computers, the provider computers, the advertiser computers, and the information gathering entity computers, can also have a respective web site, web sites, web page, and/or web pages, associated therewith.

The present invention can also be utilized with any appropriate communication system(s) including, but not limited to, network communication systems, telephone communication systems, cellular communication systems, digital communication systems, personal communication systems, personal communication services (PCS) systems, satellite communication systems, third generation (3G) communication systems, broad band communication systems, low earth orbiting (LEO) satellite systems, and/or public switched telephone networks or systems.

The apparatus and method of the present invention can be utilized in order to provide buyers of goods, products, and/or services, with any one or more of compensation, rewards, rebates, and/or incentives, for viewing, reviewing, and/or participating in, advertisements of any type, nature or kind.

The apparatus and method of the present invention can also be utilized in order to provide buyers of goods, products, and/or services, with any one or more of compensation, rewards, rebates, and/or incentives, for viewing, reviewing, and/or participating in, surveys, polls, and/or questionnaires, of any type, nature or kind.

The apparatus and method of the present invention can also be utilized in order to provide a provider, seller, or lessor (hereinafter referred to as “provider”) of goods, products, and/or services, with any one or more of compensation, rewards, rebates, and/or incentives, for viewing, reviewing, and/or participating in, advertisements of any type, nature or kind.

The apparatus and method of the present invention can also be utilized in order to provide a provider, seller, or lessor (hereinafter referred to as “provider”) of goods, products, and/or services, with any one or more of compensation, rewards, rebates, and/or incentives, for viewing, reviewing, and/or participating in, surveys, polls, and/or questionnaires, of any type, nature or kind.

The apparatus and method of the present invention can provide for compensation, a reward, a rebate, and/or incentives, for viewing, reviewing, an/or participating in and/or interacting with, the survey(s), poll(s), and/or questionnaire(s), and/or advertisements, with the respective compensation, reward, rebate, and/or incentive, being applied reduce a selling price or leasing price, in an immediate, contemporaneous, simultaneous, and/or concurrent manner.

The apparatus and method of the present invention can also provide for an immediate application of compensation, a reward, a rebate, and/or an incentive, to a purchase price or lease price. The apparatus and method of the present invention can also provide for a deferred use or application of compensation, a reward, a rebate, and/or an incentive, to a selling price or leasing price for a non-contemporaneous or non-concurrent purchase or lease transaction.

The survey(s), poll(s), and/or questionnaire(s), can be the survey(s), poll(s), and/or questionnaire(s), for goods, products, services, political the survey(s), poll(s), and/or questionnaire(s), public service the survey(s), poll(s), and/or questionnaire(s), industry the survey(s), poll(s), and/or questionnaire(s), trade group the survey(s), poll(s), and/or questionnaire(s), and/or any other type of the survey(s), poll(s), and/or questionnaire(s).

The apparatus and/or the central processing computer can determine the survey(s), poll(s), and/or questionnaire(s) to be offered and/or provided to the provider by utilizing profile information, market research information, statistical information, and/or historical information.

The apparatus and/or the central processing computer can receive funds and/or financial equivalents, and/or promises for same, from the respective advertiser(s) and/or information gathering entity or entities along with instructions on how to disseminate the respective advertisement(s), survey(s), poll(s), and/or questionnaire(s), and/or the level(s) of compensation, reward, rebate, and/or incentive, to be provided to the individual(s) or user(s). The apparatus and/or the central processing computer can also be programmed so as to determine how to disseminate the respective advertisement(s), survey(s), poll(s), and/or questionnaire(s), and/or the level(s) of compensation, reward, rebate, and/or incentive, to be provided to the individual(s) or user(s).

The apparatus and/or the central processing computer can also be programmed so as to randomly determine, on behalf of the respective advertiser(s) and/or information gathering entity or entities, how to disseminate the respective advertisement(s), survey(s), poll(s), and/or questionnaire(s), and/or the level(s) of compensation, reward, rebate, and/or incentive, to be provided to the individual(s) or user(s). The apparatus and/or the central processing computer can also be programmed so as to run or conduct contests and/or sweepstakes for, and/or to disseminate prizes for, or on behalf of, the respective advertiser(s) and/or information gathering entity or entities.

The compensation, rewards, rebates, and/or incentives, can take the form of direct price reductions, rebate checks, frequent flier rewards, financial rewards, digital money, coins, and/or tokens, coupons and/or electronic coupons for later purchases or leases of the same goods, products, and/or services, related goods, products, and/or services, and/or unrelated goods, products, and/or services.

The advertisement(s), survey(s), poll(s), and/or questionnaire(s), can be provided to the individual or provider, and the resulting compensation, rewards, rebates, and/or incentives, can be determined, prior to the individual or provider making the decision to make a respectively make a purchase of, and/or post or offer for sale or lease, the good(s), product(s), and/or service(s).

The survey(s), poll(s), and/or questionnaire(s), can be provided to the individual or provider prior to the individual or provider making the decision to respectively purchase, or offer to sell or lease, the good(s), product(s), and/or service(s), and the resulting compensation, rewards, rebates, and/or incentives, can be determined afterwards and prior to completing the posting or offering.

An individual or entity can utilize the apparatus and method of the present invention in the role(s) or individual or user, buyer, lessee, seller, lessor, provider, advertiser, and/or information gathering entity. A provider can utilize the present invention in order to sell goods, products, and/or services, to buy or lease goods, products, and/or services, to advertise goods, products, and/or services, and/or to conduct surveys regarding any appropriate topic or issue.

The central processing computer can serve as a clearinghouse for selling, leasing, and/or buying any respective goods, products, and/or services.

The apparatus and/or the central processing computer can administer and/or manage financial accounts for any of the respective parties described herein. The central processing computer can also transfer money, funds, electronic money, and/or any other financial and/or monetary value, for or on behalf of any of the parties involved in a transaction as well as perform accounting services for any of the respective parties who or which utilize the present invention.

The apparatus and/or the central processing computer can maintain and/or all financial records for any of the respective parties described herein.

In any and/or all of the embodiments described herein, the present invention can be utilized in conjunction with auctions and bidding operations and/or activities.

A user can search the database of the central processing computer in order to find advertisements and/or surveys, polls, and/or questionnaires, which they may be interested in viewing, reviewing, participating in and/or interacting with, in order to earn compensation, rewards, rebates, and/or incentives.

A user can also list requests, with any one or more of the central processing computer, a provider computer, an advertiser computer, and/or an information gathering entity computer, to be electronically notified, by telephone call, e-mail, beeper message, pager message, facsimile transmission, and/or via any other appropriate method or means, upon the posting or listing of advertisements and/or surveys, polls, and/or questionnaires, for or regarding, any goods, products, services, topics, issues, and/or subject matter, and/or having a certain level or amount of compensation, rewards, rebates, and/or incentives. Upon the posting or listing of the advertisement and/or the survey, poll, and/or questionnaire, the respective central processing computer, a provider computer, an advertiser computer, and/or an information gathering entity computer, can generate and transmit a notification message to the user computer or other communication device.

The database(s) of the central processing computer(s) can also include data and/or information concerning transactions and/or transaction histories with such data and/or information stored after each transaction or attempted transaction. The data and/or information can be compiled and processed using statistical calculations in order to update the stored historical transaction data and/or information. The stored data and/or information can then be made available to any of the individuals or entities described herein as utilizing the apparatus and method of the present invention.

The present invention, in any and/or all of the herein-described embodiments, can utilize electronic commerce technologies.

The present invention can be utilized in conjunction with intelligent agents, software agents, and/or mobile agents. The agent can be programmed to perform any and all operations, transactions, and/or functions, described herein, and/or to automate any of the operations described herein, for or on behalf of any of the respective individuals or entities described herein are utilizing the apparatus and method of the present invention.

The apparatus and method of the present invention can also be utilized by both selling and buying parties at the same time in order to allow both parties to a transaction to receive the benefits provided by the present invention.

The advertisers and/or the information gathering entities can deploy or launch their respective advertisements and/or surveys by transmitting same via their respective advertiser computers and information gathering entity computers to the central processing computer(s).

Accordingly, it is an object of the present invention to provide an apparatus and method for providing compensation for advertisement viewing and/or participation and/or for survey participation.

It is another object of the present invention to provide an apparatus and method for providing compensation for the viewing, reviewing, participation in, and/or interaction with, an advertisement or advertisements.

It is still another object of the present invention to provide an apparatus and method for providing compensation for the viewing, reviewing, participation in, and/or interaction with, a survey(s), a poll(s), and/or a questionnaire(s).

It is yet another object of the present invention to provide an apparatus and method for providing compensation, rewards, rebates, and/or incentives, for advertisement viewing and/or participation and/or for survey participation it is another object of the present invention to provide an apparatus and method for providing compensation for advertisement viewing and/or participation and/or for survey participation, which provides compensation, a reward, a rebate, and/or an incentive, to a buyer of goods and/or services for facilitating commerce between parties.

It is still another object of the present invention to provide an apparatus and method for providing compensation for advertisement viewing and/or participation and/or for survey participation, which provides compensation, a reward, a rebate, and/or an incentive, to a seller of goods and/or services for facilitating commerce between parties.

It is yet another object of the present invention to provide an apparatus and method for providing compensation for advertisement viewing and/or participation and/or for survey participation, which provides compensation, a reward, a rebate, and/or an incentive, to a any number of parties, to, or involving, a transaction or potential transaction.

It is another object of the present invention to provide an apparatus and method for providing compensation for advertisement viewing and/or participation and/or for survey participation, which can be applied towards a respective transaction in order to lower the price which the buyer will pay for goods, products, and/or services.

It is still another object of the present invention to provide an apparatus and method for providing compensation for advertisement viewing and/or participation and/or for survey participation, which can be applied towards a respective transaction in order to lower the selling or leasing price for goods, products, and/or services.

It is yet another object of the present invention to provide an apparatus and method for providing compensation, a reward(s), a rebate(s), and/or an incentive(s), for advertisement viewing and/or participation and/or for survey participation, which can be utilized at any time, in a concurrent manner, in an immediate manner, in a deferred manner, and/or which can be transferred to a third party.

It is another object of the present invention to provide an apparatus and method for providing compensation for advertisement viewing and/or participation and/or for survey participation, which can provide compensation, rewards, rebates, and/or incentive, to multiple parties to a transaction.

It is still another object of the present invention to provide an apparatus and method for providing compensation for advertisement viewing and/or participation and/or for survey participation, which can be utilized to disseminate advertisements, surveys, polls, and/or questionnaires while providing compensation for individuals who view and/or participate in same.

It is yet another object of the present invention to provide an apparatus and method for providing compensation for advertisement viewing and/or participation and/or for survey participation, which can be utilized with any kind or type of computer and/or communication device.

It is another object of the present invention to provide an apparatus and method for providing compensation for advertisement viewing and/or participation and/or for survey participation, which can be utilized with any appropriate communication system(s).

It is still another object of the present invention to provide an apparatus and method for providing compensation for advertisement viewing and/or participation and/or for survey participation, which can be utilized in order to provide buyers of goods, products, and/or services, with any one or more of compensation, rewards, rebates, and/or incentives, for viewing, reviewing, and/or participating in, surveys, polls, and/or questionnaires, of any type, nature or kind.

It is yet another object of the present invention to provide an apparatus and method for providing compensation for advertisement viewing and/or participation and/or for survey participation, which can be utilized in order to provide a provider, seller, or lessor of goods, products, and/or services, with any one or more of compensation, rewards, rebates, and/or incentives, for viewing, reviewing, and/or participating in, advertisements of any type, nature or kind.

It is another object of the present invention to provide an apparatus and method for providing compensation for advertisement viewing and/or participation and/or for survey participation, which can determine the advertisement(s), survey(s), poll(s), and/or questionnaire(s), to be offered and/or to be provided to the respective individual or party by utilizing profile information, market research information, statistical information, and/or historical information.

It is still another object of the present invention to provide an apparatus and method for providing compensation for advertisement viewing and/or participation and/or for survey participation, wherein the compensation can be determined prior to a respective party making a decision to make a purchase of a good, product, or service, and/or to post or offer a good, product, or service, for sale or lease.

It is yet another object of the present invention to provide an apparatus and method for providing compensation for advertisement viewing and/or participation and/or for survey participation, wherein the compensation can be determined afterwards and prior to completing the respective purchase, posting, or offering.

It is another object of the present invention to provide an apparatus and method for providing compensation for advertisement viewing and/or participation and/or for survey participation, wherein the central processing computer can serve as a clearinghouse for selling, leasing, and/or buying any respective goods, products, and/or services.

It is still another object of the present invention to provide an apparatus and method for providing compensation for advertisement viewing and/or participation and/or for survey participation, wherein the central processing computer can administer and/or manage financial accounts for any of the respective parties who or which utilize the present invention.

It is yet another object of the present invention to provide an apparatus and method for providing compensation for advertisement viewing and/or participation and/or for survey participation, wherein the central processing computer can perform accounting services for any of the respective parties who or which utilize the present invention.

It is another object of the present invention to provide an apparatus and method for providing compensation for advertisement viewing and/or participation and/or for survey participation, which can be utilized in conjunction with auctions and bidding operations and/or activities.

It is still another object of the present invention to provide an apparatus and method for providing compensation for advertisement viewing and/or participation and/or for survey participation, wherein a user can perform a search the in order to find advertisements and/or surveys, polls, and/or questionnaires, which he or she may be interested in viewing, reviewing, participating in and/or interacting with.

It is yet another object of the present invention to provide an apparatus and method for providing compensation for advertisement viewing and/or participation and/or for survey participation, which can provide notification to a user upon the posting or listing of advertisements and/or surveys, polls, and/or questionnaires.

It is another object of the present invention to provide an apparatus and method for providing compensation for advertisement viewing and/or participation and/or for survey participation which can receive funds and/or financial equivalents, and/or promises for same, from the respective advertiser(s) and/or information gathering entity or entities along with instructions on how to disseminate the respective advertisement(s), survey(s), poll(s), and/or questionnaire(s), and/or the level(s) of compensation, reward, rebate, and/or incentive, to be provided to the individual(s) or user(s).

It is still another object of the present invention to provide an apparatus and method for providing compensation for advertisement viewing and/or participation and/or for survey participation which can be programmed so as to determine how to disseminate the respective advertisement(s), survey(s), poll(s), and/or questionnaire(s), and/or the level(s) of compensation, reward, rebate, and/or incentive, to be provided to the individual(s) or user(s).

It is yet another object of the present invention to provide an apparatus and method for providing compensation for advertisement viewing and/or participation and/or for survey participation which can be programmed so as to randomly determine, on behalf of the respective advertiser(s) and/or information gathering entity or entities, how to disseminate the respective advertisement(s), survey(s), poll(s), and/or questionnaire(s), and/or the level(s) of compensation, reward, rebate, and/or incentive, to be provided to the individual(s) or user(s).

It is still another object of the present invention to provide an apparatus and method for providing compensation for advertisement viewing and/or participation and/or for survey participation which can be programmed to run or conduct contests and/or sweepstakes for, and/or to disseminate prizes for, or on behalf of, the respective advertiser(s) and/or information gathering entity or entities.

It is another object of the present invention to provide an apparatus and method for providing compensation for advertisement viewing and/or participation and/or for survey participation, which can utilize electronic commerce technologies.

It is still another object of the present invention to provide an apparatus and method for providing compensation for advertisement viewing and/or participation and/or for survey participation, which can be utilized in conjunction with intelligent agents, software agents, and/or mobile agents.

It is yet another object of the present invention to provide an apparatus and method for providing compensation for advertisement viewing and/or participation and/or for survey participation, which allows advertisers and/or the information gathering entities to deploy or launch their respective advertisements and/or surveys, polls, and/or questionnaires.

Other objects and advantages of the present invention will be apparent to those skilled in the art upon a review of the Description of the Preferred Embodiment taken in conjunction with the Drawings which follow.

### BRIEF DESCRIPTION OF THE DRAWINGS

In the Drawings:

FIG. 1 illustrates the apparatus of the present invention, in block diagram form;

FIG. 2 illustrates the central processing computer of FIG. 1, in block diagram form;

FIG. 3 illustrates the database of the central processing computer of FIG. 2;

FIG. 4 illustrates the user computer of FIG. 1, in block diagram form;

FIG. 5 illustrates the provider computer of FIG. 1, in block diagram form;

FIG. 6 illustrates the advertiser computer of FIG. 1, in block diagram form;

FIGS. 7A, 7B, 7C and 7D illustrate a flow diagram of a preferred embodiment method for utilizing the apparatus of the present invention;

FIGS. 8A, 8B, 8C and 8D illustrate a flow diagram of another preferred embodiment method for utilizing the apparatus of the present invention;

FIGS. 9A, 9B and 9C illustrate a flow diagram of a preferred embodiment method for utilizing the apparatus of the present invention; and

FIGS. 10A, 10B and 10C illustrate a flow diagram of another preferred embodiment method for utilizing the apparatus of the present invention.

### DESCRIPTION OF THE PREFERRED EMBODIMENTS

The present invention pertains to an apparatus and method for providing compensation for advertisement viewing and/or participation and/or for survey participation and, in particular, to an apparatus and method for providing compensation to individuals or entities who or which view, review, and/or participate in and/or interact with, advertisements, and/or for providing compensation to individuals or entities who or which view, review, and/or participate in and/or interact with, surveys, polls, questionnaires, and/or other information gathering efforts and/or activities.

The apparatus and method of the present invention also pertains to an apparatus and method for providing compensation-based advertising commerce and, in particular, to an apparatus and method for providing compensation to a buyer of goods and/or services and/or to a seller of goods and/or services so as to provide compensation, a reward, a rebate, and/or an incentive, to facilitating commerce between parties.

The apparatus and method of the present invention provides compensation-based advertising to a respective party, and/or to any number of parties, to, or involving, a potential transaction. A respective party or parties can receive compensation, a reward, a rebate, and/or an incentive, which can be utilized to facilitate commerce between any parties and/or any number of parties.

In the case of a buyer(s) of goods and/or services, a buyer(s) can view and/or participate in an advertisement for any good, product, and/or service, receive compensation, a reward, a rebate, and/or an incentive, which can be utilized by and/or applied towards a respective transaction in order to lower the price which the buyer will pay for the goods, products, and/or services. In this manner, a buyer or buyers can utilize and/or apply the respective compensation, reward, rebate, and/or incentive, to a respective transaction involving any goods, products, and/or services, in order to obtain the respective goods, products, and/or services, at a lower price or cost. The apparatus and method of the present invention allows an individual or entity to earn compensation, rewards, rebates, and/or incentives, for viewing, reviewing, participating in and/or interacting with, advertisements and/or advertisement material. The compensation, rewards, rebates, and/or incentives, can be used by the individual or entity to lower a purchase price, a lease price. The compensation, rewards, rebates, and/or incentives, can also be utilized at any time, in a concurrent manner, in an immediate manner, in a deferred manner, and/or can be transferred to a third party.

In the case of a seller(s) of goods and/or services, a seller can view and/or participate in an advertisement for any good, product, and/or service, receive compensation, a reward, a rebate, and/or an incentive, which can be utilized by and/or applied towards lowering the selling price of the goods and/or services offered for sale by the seller. In this manner, a seller or sellers can utilize and/or apply the respective compensation, reward, rebate, and/or incentive, to a respective transaction involving any goods, products, and/or services, in order to obtain to lower the selling price of the respective goods, products, and/or services.

The apparatus and method of the present invention allows a provider or seller of goods, products, and/or services, to earn compensation, rewards, rebates, and/or incentives, for viewing, reviewing, participating in and/or interacting with, advertisements and/or advertisement material. The compensation, rewards, rebates, and/or incentives, can be used by the provider or seller to lower a selling price or a leasing price. The compensation, rewards, rebates, and/or incentives, can also be utilized at any time, in a concurrent manner, in an immediate manner, in a deferred manner, and/or can be transferred to a third party.

In the case of buyers and sellers both utilizing the apparatus and method of the present invention in a same transaction, both the buyer(s) and seller(s) can obtain compensation, a reward, a rebate, and/or an incentive, from viewing and/or participating in respective advertisements, thereby resulting in compensation, rewards, rebates, and/or incentives flowing to both parties to a transaction and, therefore, enhanced savings for buyers and enhanced profits for sellers.

The advertising or advertisements can take any form and can include, but not be limited to, text advertisements, text/graphics advertisements, video advertisements, audio advertisements, audio-video advertisements, graphical advertisements such as buttons, banners, and the like.

The present invention can also provide compensation, rewards, rebates, and/or incentives, for and/or in conjunction with surveys, marketing surveys, market research surveys, questionnaires, marketing questionnaires, market research questionnaires, etc., which can be utilized instead of advertisements, and/or in addition to advertisements, in any and/or all of the embodiments described herein.

The apparatus and method of the present invention an be utilized to disseminate advertisements and/or to compensate and/or reward individuals and/or parties for viewing and/or participating in these advertisements. In this manner, advertisers can get their massage across to interested individuals and/or parties and/or compensate individuals and/or parties for their attention, time, and/or participation.

In the case of surveys and/or questionnaires, the party conducting the survey of circulating or providing the questionnaire can obtain the desired information while the individuals and/or parties who or which respond to the surveys or questionnaire can be compensated for the information they provided and/or for their time and efforts in responding to same.

Applicant hereby incorporates by reference herein the subject matter and teachings of U.S. Provisional Patent Application Ser. No. 60/213,331 which teaches and discloses an apparatus and method for providing compensation for advertisement viewing and/or participation and/or for survey participation.

As utilized herein, the terms “user”, “individual”, “client”, “buyer”, “seller”, “operator”, “party”, and/or the plurals of same, refer to any user, individual, client, buyer, seller, operator, and/or party, who or which utilizes the present invention as described herein.

As utilized herein, the terms “provider”, “seller”, “goods provider”, “products provider”, “services provider”, or the plurals of same, refer to any provider, seller, goods provider, products provider, services provider and/or other individual and/or party who or which utilizes the present invention to sell goods, products, and/or services, who or which offers to sell goods, products, and/or services, and/or who or which advertise goods, products, and/or services, as described herein.

As utilized herein, the terms “advertiser”, “advertising party”, “research individual”, “market research individual”, “survey conducting party”, “information gathering individual”, “information gathering entity”, “questionnaire issuing individual”, and/or the plurals of same, refer to any user, individual, client, buyer, seller, operator, party, advertiser, advertising party, research individual, market research individual, survey conducting party, information gathering individual, information gathering entity, questionnaire issuing individual, and/or source of any advertisement, survey, and/or questionnaire, and/or agent, broker, and/or representative of any of the herein described individuals and/or parties who or which utilize the present invention as described herein to provide any of the respective advertisement, survey, questionnaire, and/or information gathering services described herein.

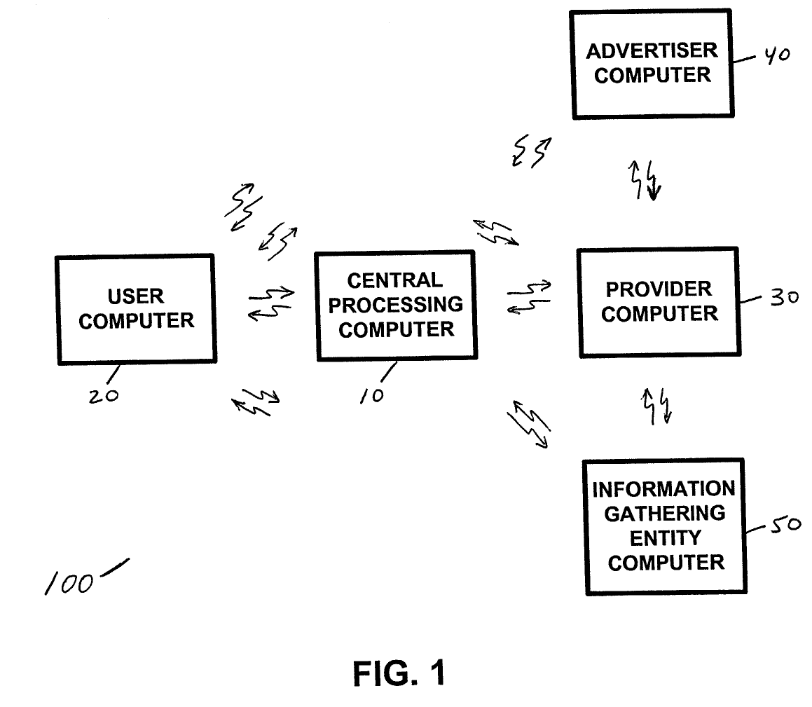

FIG. 1 illustrates a preferred embodiment of the apparatus of the present invention which is designated generally by the reference numeral 100. In FIG. 1, the apparatus 100 includes a central processing computer or server computer 10. The central processing computer 10 provides control over the apparatus 100 and provides services for the various computers associated with the various individuals, users, clients, providers, advertisers and/or information gathering parties, who or which utilize the present invention.

The central processing computer 10, in the preferred embodiment, can be any suitable computer, network computer, or computer system, for providing service for the various computers associated with the various individuals, users, clients, providers, advertisers and/or information gathering parties, who or which utilize the present invention.

In the preferred embodiment, any number of central processing computers 10 can be utilized in order to provide the servicing functions described herein. The central processing computers 10 can be linked to other central processing computers or may be stand alone devices. A given central processing computer 10 may service a particular geographic area or certain individuals, users, clients, providers, advertisers and/or information gathering parties, who or which utilize the present invention. A central processing computer 10 may also be dedicated to service any one or group of the above described individuals and/or entities.

The apparatus 100, in the preferred embodiment, also includes any number of user computers 20. Each user computer 20 can be a personal computer or other communication device which is suitable for allowing the user to interact with the central processing computer(s) 10 and/or with any of the other computers and/or communication devices described herein. Each user computer 20 can be associated with any of the individuals, users, clients, providers, advertisers and/or information gathering parties, who or which utilize the apparatus and method of the present invention and/or any broker(s), agent(s), and/or representative(s) of same.

Each user computer 20 can be utilized to transmit information to the central processing computer 10 and to receive information from the central processing computer 10 via the communication network.

The user computer 20 can be a personal computer, a hand-held computer, a palmtop computer, a laptop computer, a personal communication device, a personal digital assistant, a telephone, a wireless telephone, a digital telephone, a third generation (3G) telephone, a video telephone, a videophone, a television, an interactive television, a beeper, a pager, and/or a watch. The user computer 20 can also be a wireless communication device(s) and/or can be utilized in a wireless communications network or environment. In the present invention, any number of user computers 20 can be utilized. In the present invention, each client or individual utilizing the present invention may have one or more user computers 20 associated therewith.

The apparatus 100, in the preferred embodiment, also includes one or more provider computers 30. Each provider computer 30 may be a personal computer or other communication device suitable for allowing the provider to interact with the central processing computer(s) 10 and/or with any of the other computers and/or communication devices described herein. Each provider computer 30 can be associated with any of the provider(s) of any goods, products and/or services, who or which utilize the apparatus and method of the present invention, and/or any broker(s), agent(s), and/or representative(s) of same.

The provider computer(s) 30 can be a personal computer, a server computer, a central processing computer, a mainframe computer, a hand-held computer, a palmtop computer, a laptop computer, a personal communication device, a personal digital assistant, a telephone, a wireless telephone, a digital telephone, a third generation (3G) telephone, a video telephone, a videophone, a television, an interactive television, a beeper, a pager, and/or a watch. The provider computer 30 can also be a wireless communication device(s) and/or can be utilized in a wireless communications network or environment. In the present invention, any number of provider computers 30 can be utilized. In the present invention, each provider utilizing the present invention may have one or more provider computers 30 associated therewith.

Each provider computer 30 can be utilized to transmit information to the central processing computer 10 and receive information from the central processing computer 10 via the communication network. Each provider computer 30 can transmit information to and receive information from any of the user computers 20 and/or provider computers 30 described herein.

The apparatus 100, in the preferred embodiment, also includes one or more advertiser computers 40. Each advertiser computer 40 may be a personal computer or other communication device suitable for allowing the advertiser to interact with the central processing computer(s) 10 and/or with any of the other computers and/or communication devices described herein. Each advertiser computer 40 can be associated with any advertiser, advertising provider(s) of any goods, products and/or services, and/or advertising agent, who or which utilize the apparatus and method of the present invention, and/or any broker(s), agent(s), and/or representative(s) of same.

The advertiser computer(s) 40 can be a personal computer, a server computer, a central processing computer, a mainframe computer, a hand-held computer, a palmtop computer, a laptop computer, a personal communication device, a personal digital assistant, a telephone, a wireless telephone, a digital telephone, a third generation (3G) telephone, a video telephone, a videophone, a television, an interactive television, a beeper, a pager, and/or a watch. The advertiser computer 40 can also be a wireless communication device(s) and/or can be utilized in a wireless communications network or environment. In the present invention, any number of advertiser computers 40 can be utilized. In the present invention, each advertiser utilizing the present invention may have one or more advertiser computers 40 associated therewith.

Each advertiser computer 40 can be utilized to transmit information to the central processing computer 10 and receive information from the central processing computer 10 via the communication network. Each advertiser computer 40 can transmit information to and receive information from any of the user computers 20, provider computers 30, and/or advertiser computers 40 described herein.

The apparatus 100, in the preferred embodiment, also includes one or more information gathering entity computers 50. Each information gathering entity computer 50 may be a personal computer or other communication device suitable for allowing the information gathering entity to interact with the central processing computer(s) 10 and/or with any of the other computers and/or communication devices described herein. Each information gathering entity computer 50 can be associated with any information gathering entity who or which utilize the apparatus and method of the present invention, and/or any broker(s), agent(s), and/or representative(s) of same.

The information gathering entity computer(s) 50 can be a personal computer, a server computer, a central processing computer, a mainframe computer, a hand-held computer, a palmtop computer, a laptop computer, a personal communication device, a personal digital assistant, a telephone, a wireless telephone, a digital telephone, a third generation (3G) telephone, a video telephone, a videophone, a television, an interactive television, a beeper, a pager, and/or a watch. The information gathering entity computer(s) 50 can also be a wireless communication device(s) and/or can be utilized in a wireless communications network or environment. In the present invention, any number of information gathering entity computers 50 can be utilized. In the present invention, each information gathering entity utilizing the present invention may have one or more information gathering entity computer(s) 50 associated therewith.

Each information gathering entity computer(s) 50 can be utilized to transmit information to the central processing computer 10 and receive information from the central processing computer 10 via the communication network. Each information gathering entity computer(s) 50 can transmit information to and receive information from any of the user computers 20, provider computers 30, advertiser computers 40, and/or information gathering computers 50 described herein.

Any of the central processing computers 10, the user computers 20, the provider computers 30, the advertiser computers 40, and the information gathering entity computers 50 can transmit information to and receive information from any of the central processing computers 10, the user computers 20, the provider computers 30, the advertiser computers 40, and the information gathering entity computers 50, described herein and/or can transmit information to and receive information from any of the other central processing computers 10, the user computers 20, the provider computers 30, the advertiser computers 40, and the information gathering entity computers 50 described herein.

Each of the central processing computers 10, the user computers 20, the provider computers 30, the advertiser computers 40, and the information gathering entity computers 50 can be wireless communication devices, and/or can be computers or other processing devices and/or communication devices which can operate in a wireless communication environment, in a wired or line-connected environment, and/or in an combination and/or hybrid environment(s).

The central processing computers 10, the user computers 20, the provider computers 30, the advertiser computers 40, and the information gathering entity computers 50, can communicate with one another, and/or be linked to one another, over a communication network and/or a wireless communication network. In the preferred embodiment, the present invention is utilized on, and/or over, the Internet and/or the World Wide Web. The present invention, in the preferred embodiment, can also utilize wireless Internet and/or World Wide Web services, equipment and/or devices. The central processing computer(s) 10, in the preferred embodiment, has a respective web site, web sites, web page, and/or web pages, associated therewith. Any of the user computers 20, the provider computers 30, the advertiser computers 40, and the information gathering entity computers 50, can also have a respective web site, web sites, web page, and/or web pages, associated therewith.

Although the Internet and/or the World Wide Web is described as being a preferred communication system and/or medium utilized, the present invention, in all of the embodiments described herein, can also be utilized with any appropriate communication system(s) including, but not limited to, network communication systems, telephone communication systems, cellular communication systems, digital communication systems, personal communication systems, personal communication services (PCS) systems, satellite communication systems, third generation (3G) communication systems, broad band communication systems, low earth orbiting (LEO) satellite systems, and/or public switched telephone networks or systems.

In the preferred embodiment, each of the central processing computers 10, the user computers 20, the provider computers 30, the advertiser computers 40, and the information gathering entity computers 50, can transmit data and/or information using TCP/IP, as well as any other Internet and/or World Wide Web, protocols.

In the preferred embodiment, and of the central processing computers 10, the user computers 20, the provider computers 30, the advertiser computers 40, and the information gathering entity computers 50, can be linked directly or indirectly with any other central processing computers 10, the user computers 20, the provider computers 30, the advertiser computers 40, and the information gathering entity computers 50. In this manner, any of the central processing computers 10, the user computers 20, the provider computers 30, the advertiser computers 40, and the information gathering entity computers 50, can be linked, directly and/or indirectly, with any other central processing computers 10, the user computers 20, the provider computers 30, the advertiser computers 40, and the information gathering entity computers 50, so as to facilitate a direct or indirect bi-directional communication between any of the respective computers.

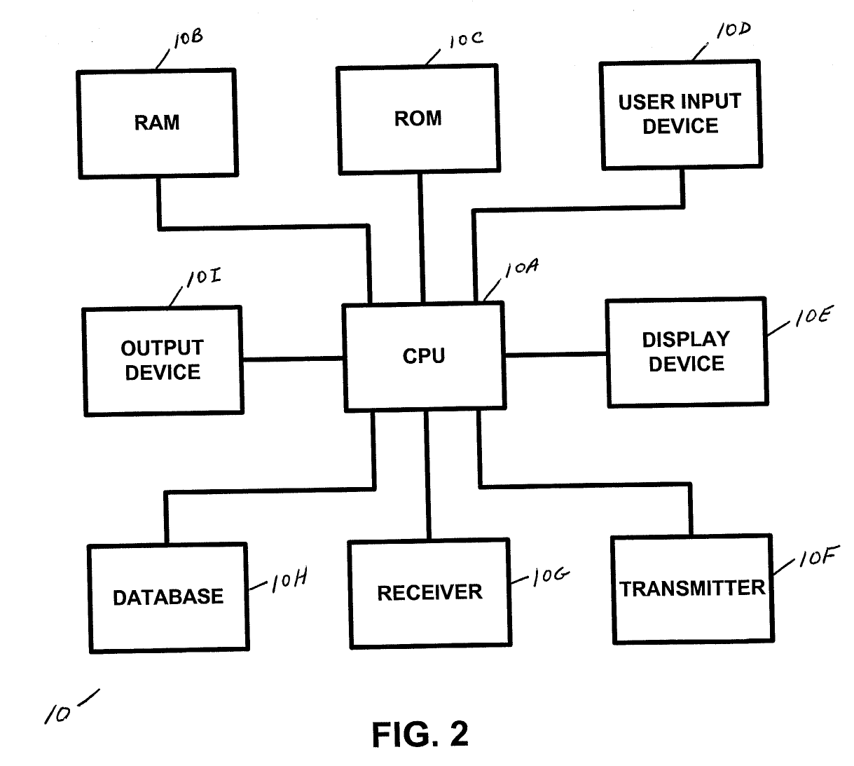

FIG. 2 illustrates the central processing computer 10, in block diagram form. The central processing computer 10, in the preferred embodiment, is a network computer or computer system which can be utilized as a central processing computer, an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, and/or an audio input device and/or a video input device, etc., if desired, which input device(s) are also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of the user computers 20, the provider computers 30, the advertiser computers, and/or the information gathering entity computers 50, and/or to any other central processing computer(s) 10, which may be utilized in conjunction with the present invention. The central processing computer 10 also includes a receiver 10G, for receiving signals and/or data and/or information from any one or more of the user computers 20, the provider computers 30, the advertiser computers, and/or the information gathering entity computers 50, and/or to any other central processing computer(s) 10.

The central processing computer 10 also includes a database(s) 10H which contains data and/or information pertaining to any of the users, operators, providers, advertisers, and information gathering entities, who or which utilize the apparatus and method of the present invention. The database 10H can include any data and/or information needed and/or desired for performing any of the functions and/or services described herein as being provided by the apparatus and method of the present invention.

The database 10H can contain, for example, name, address, phone number, facsimile number, e-mail address, and/or any other information regarding any of the individuals, users, providers, advertisers, and information gathering entities described herein.

The database can store information regarding the types of goods, products, and/or services, that individuals and/or users are interested in purchasing, goods, products, and/or services, that individuals and/or users are interested in receiving information about, buying habits and/or buying patterns for an individual, individuals, a user, or users, past purchase information, including the types of goods, products, and/or services, purchased and/or their corresponding prices, credit, charge, and/or debit card and/or account information, financial account information, the types or kinds of advertisements (i.e. goods, products, services, price ranges, providers, text, videos, audio-visuals, etc.) which they desire to receive, review and/or participate in, types or kinds of surveys and/or questionnaires (i.e. subject matter, issues, goods, products, services, price ranges, providers, text, videos, audio-visuals, etc.) which they desire to receive, review and/or participate in, etc. The database 10H can also contain any other individual-related and/or user-related information which can be needed and/or desired for facilitating the operation of the apparatus and method of the present invention.

The database 10H can also contain data and/or information regarding the providers of goods, products, and/or services, and the respective goods, products, and/or services, provided by the respective providers. The database 10H can also contain information regarding the descriptions and prices of any of the respective goods, products, and/or services, described as being offered for sale via the apparatus and method of the present invention. The database 10H can also contain any other provider-related information which can be needed and/or desired for facilitating the operation of the apparatus and method of the present invention.

The database 10H can also contain data and/or information regarding the various advertisers who or which utilize the present invention. The database 10H can also contain the various advertisements and types of advertisements for ant of the goods, products and/or services, which are advertised via the apparatus and method of the present invention. The database 10H can contain advertisements, such as text advertisements, video advertisements, audio advertisements, graphical, banner and/or button, advertisements, audio-visual advertisements, interactive advertisements of any of the above-described variety, dynamic advertisements, static advertisements, along with the amounts of compensation, the reward, the rebate, and/or the incentive, for viewing, and/or for participating in, the advertisement. The database 10H can also contain any data and/or information for or regarding calculating a respective compensation, reward, rebate, and/or incentive, for any individual or user who has viewed and/or participated in an advertisement(s).

The database 10H also contains data and/or information regarding the preferences of individuals and/or users to receive certain advertisements, data and/or information correlating advertisements with the purchase or sale of certain goods, products, and/or services, and/or any other data and/or information needed and/or desired for facilitating the operation of the apparatus and method of the present invention as described herein.

The database 10H can also contain data and/or information regarding the various information gathering entities who or which utilize the present invention. The database 10H can also contain the various surveys, polls, polling information, and/or questionnaires, and types of surveys, polls, polling information, questionnaires, which are to be provided via, and/or in conjunction with, the apparatus and method of the present invention. The database 10H can contain surveys, polls, polling information, and/or questionnaires, for any of the goods, products and/or services, which are sold or offered for sale and/or advertised via the apparatus and method of the present invention.

The database 10H can also contain surveys, polls, polling information, and/or questionnaires, such as text surveys, polls, polling information, and/or questionnaires, video surveys, polls, polling information, and/or questionnaires, audio surveys, polls, polling information, and/or questionnaires, graphical, banner and/or button, surveys, polls, polling information, and/or questionnaires, audio-visual surveys, polls, polling information, and/or questionnaires, interactive surveys, polls, polling information, and/or questionnaires, of any of the above-described variety, dynamic surveys, polls, polling information, and/or questionnaires, static surveys, polls, polling information, and/or questionnaires, along with the amounts of compensation, the reward, the rebate, and/or the incentive, for viewing, and/or for participating in, the surveys, polls, polling information, and/or questionnaires. The database 10H can also contain any data and/or information for or regarding calculating a respective compensation, reward, rebate, and/or incentive, for any individual or user who has viewed and/or participated in an surveys, polls, polling information, and/or questionnaires.

The database 10H can also contain data and/or information regarding the preferences of individuals and/or users to receive and/or to participate in certain surveys, polls, polling information, and/or questionnaires, data and/or information correlating surveys, polls, polling information, and/or questionnaires, with the purchase or sale of certain goods, products, and/or services, and/or any other data and/or information needed and/or desired for facilitating the operation of the apparatus and method of the present invention as described herein.

The database 10H can also contain e-mail, linking information, hyperlink information, and/or any other contact information for facilitating communication between any of the central processing computers 10, the user computers 20, the provider computers 30, the advertiser computers 40, and the information gathering entity computers 50, described herein.

The database 10H can also contain profile or profiling information for any of the individuals or users, providers, advertisers, and/or information gathering entities described herein. The profile or profiling information can be utilized to identify individuals or users to whom advertisements, surveys, polls, and/or questionnaires may be directed. The database 10H can also contain profile or demographic information which can also include, but not be limited to, individual or user sex, age, residence, citizenship, background, ethnic background, purchasing history, leasing history, income, spending habits, spending patterns, buying habits, buying patterns, leasing habits, leasing patterns, previously purchased goods, products, and/or services, past responses to advertisements, past compensation, rewards, rebates, and/or incentives, earned, and/or any other information and/or data which can be utilized in identifying advertisements, surveys, polls, and/or advertisements, which can be provided to and/or which can be directed to the respective individuals or users described herein.

The database 10H can also include financial information, account information, and/or accounting information, for accounts associated with any of the individuals or users, providers, advertisers, and/or information gathering entities, described herein.

The database 10H can also contain any data, information, software programs, and/or software algorithms, which can be needed and/or desired for performing the processing routines and/or functions described herein.

With reference once again to FIG. 2, the central processing computer 10 also includes an output device 10I such as a printer, a modem, a fax/modem, or other output device, for providing data and/or information to the operator or user of the central processing computer 10 or to a third party or third party entity.

In the preferred embodiment, each of the user computers 20, the provider computers 30, the advertiser computers 40, and the information gathering entity computers 50, can include the same, similar, or analogous, components and/or peripheral devices as described herein for the central processing computer 10. In this manner, any of the user computers 20, the provider computers 30, the advertiser computers 40, and the information gathering entity computers 50, may be the same as, or be similar to, the central processing computer 10. In this regard, and depending upon the application, each of the user computers 20, the provider computers 30, the advertiser computers 40, and the information gathering entity computers 50, can have the same or similar components as the central processing computer 10.

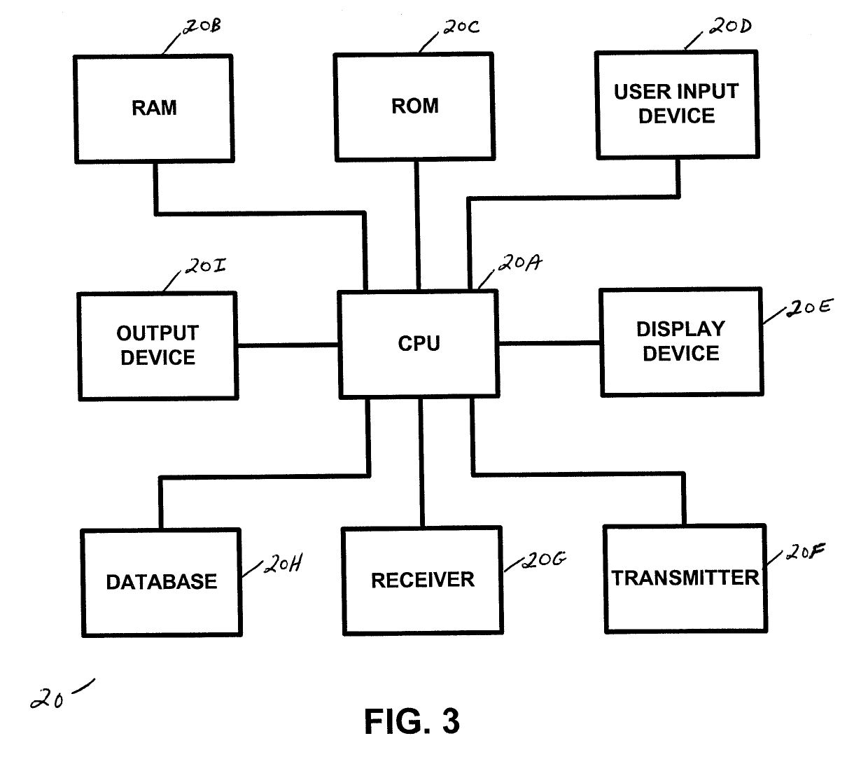

FIG. 3 illustrates the user computer 20, in block diagram form. The user computer 20, in the preferred embodiment, is a computer or communication device which can be utilized as a user computer. In the preferred embodiment, the user computer 20 includes a central processing unit or CPU 20A, which in the preferred embodiment, is a microprocessor. The CPU 20A may also be a microcomputer, a minicomputer, a macro-computer, and/or a mainframe computer, depending upon the application.

The user computer 20 also includes a random access memory device(s) 20B (RAM) and a read only memory device(s) 20C (ROM), each of which is connected to the CPU 20A, a user input device 20D, for entering data and/or commands into the user computer 20, which includes any one or more of a keyboard, a scanner, a user pointing device, such as, for example, a mouse, a touch pad, and/or an audio input device and/or a video input device, etc., if desired, which input device(s) are also connected to the CPU 20A. The user computer 20 also includes a display device 20E for displaying data and/or information to a user or operator.

The user computer 20 also includes a transmitter(s) 10F, for transmitting signals and/or data and/or information to any one or more of the central processing computer(s) 10, the provider computers 30, the advertiser computers, and/or the information gathering entity computers 50, and/or any of the other user computers 20, which may be utilized in conjunction with the present invention. The user computer 10 also includes a receiver 10G, for receiving signals and/or data and/or information from any one or more of the central processing computer(s) 10, the provider computers 30, the advertiser computers, and/or the information gathering entity computers 50, and/or to any other user computer(s) 20.

The user computer 20 can also include a database(s) 20H which contains data and/or information pertaining to any of the users, operators, providers, advertisers, and information gathering entities, who or which utilize the apparatus and method of the present invention. The database 20H can include any data and/or information needed and/or desired for performing any of the functions and/or services described herein as being provided by the apparatus and method of the present invention. The database 20H can contain any of the data and/or information described herein as being stored and/or utilized by the database 10H of the central processing computer 10.

The database 20H can also contain, for example, name, address, phone number, facsimile number, e-mail address, and/or any other information regarding any of the individuals, users, providers, advertisers, and information gathering entities described herein.

With reference once again to FIG. 3, the user computer 20 also includes an output device 20I such as a printer, a modem, a fax/modem, or other output device, for providing data and/or information to the individual or user of the user computer 20.

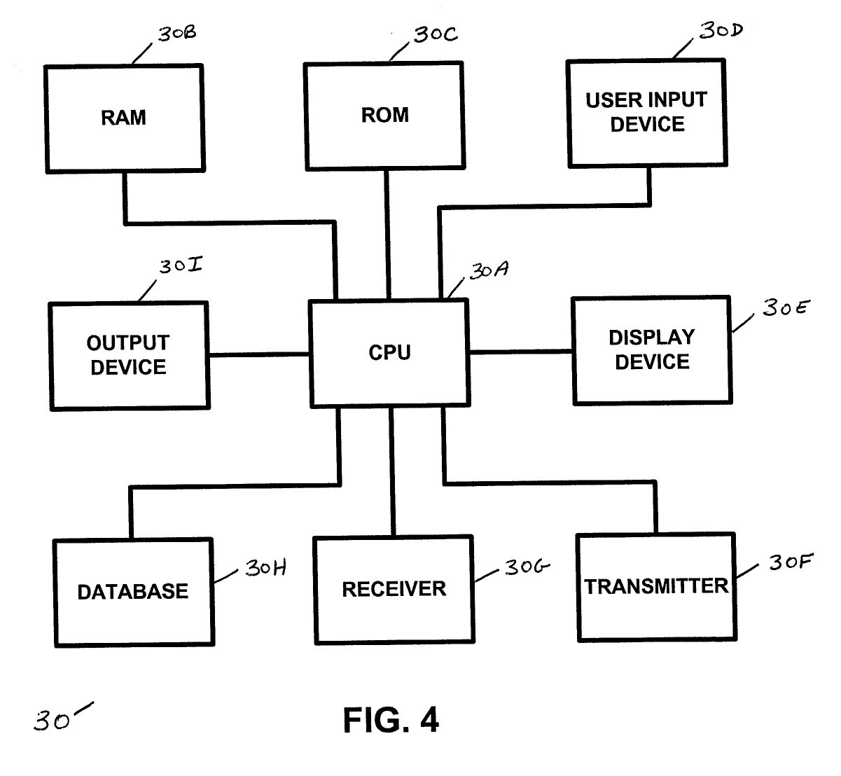

FIG. 4 illustrates the provider computer 30, in block diagram form. The provider computer 30, in the preferred embodiment, is a computer or communication device which can be utilized as a provider computer. In the preferred embodiment, the provider computer 30 includes a central processing unit or CPU 30A, which in the preferred embodiment, is a microprocessor. The CPU 30A may also be a microcomputer, a minicomputer, a macro-computer, and/or a mainframe computer, depending upon the application.

The provider computer 30 also includes a random access memory device(s) 30B (RAM) and a read only memory device(s) 30C (ROM), each of which is connected to the CPU 30A, a user input device 30D, for entering data and/or commands into the provider computer 30, which includes any one or more of a keyboard, a scanner, a user pointing device, such as, for example, a mouse, a touch pad, and/or an audio input device and/or a video input device, etc., if desired, which input device(s) are also connected to the CPU 30A. The provider computer 30 also includes a display device 30E for displaying data and/or information to a user or operator.

The provider computer 30 also includes a transmitter(s) 30F, for transmitting signals and/or data and/or information to any one or more of the central processing computer(s) 10, the user computers 20, the advertiser computers 40, and/or the information gathering entity computers 50, and/or any of the other provider computers 30, which may be utilized in conjunction with the present invention. The provider computer 30 also includes a receiver 30G, for receiving signals and/or data and/or information from any one or more of the central processing computer(s) 10, the user computers 20, the advertiser computers, and/or the information gathering entity computers 50, and/or to any other provider computer(s) 30.

The provider computer 30 can also include a database(s) 30H which contains data and/or information pertaining to any of the users, operators, providers, advertisers, and information gathering entities, who or which utilize the apparatus and method of the present invention. The database 30H can include any data and/or information needed and/or desired for performing any of the functions and/or services described herein as being provided by the apparatus and method of the present invention. The database 30H can contain any of the data and/or information described herein as being stored and/or utilized by the database 10H of the central processing computer 10.

The database 30H can also contain, for example, name, address, phone number, facsimile number, e-mail address, and/or any other information regarding any of the individuals, users, providers, advertisers, and information gathering entities described herein.

With reference once again to FIG. 4, the provider computer 30 also includes an output device 30I such as a printer, a modem, a fax/modem, or other output device, for providing data and/or information to the individual or user of the provider computer 30.

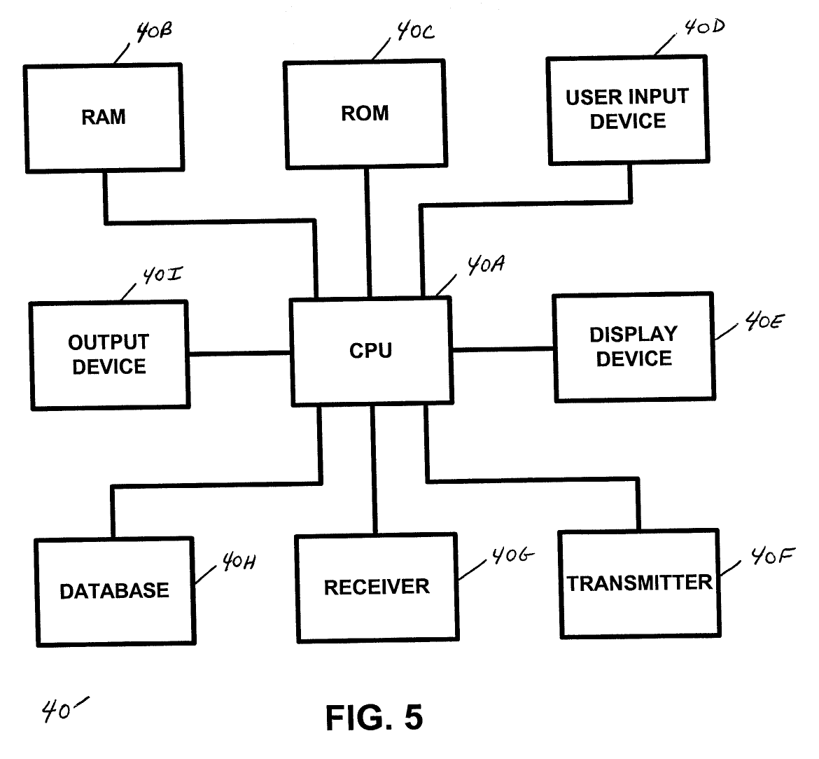

FIG. 5 illustrates the advertiser computer 40, in block diagram form. The advertiser computer 40, in the preferred embodiment, is a computer or communication device which can be utilized as an advertiser computer. In the preferred embodiment, the advertiser computer 40 includes a central processing unit or CPU 40A, which in the preferred embodiment, is a microprocessor. The CPU 40A may also be a microcomputer, a minicomputer, a macro-computer, and/or a mainframe computer, depending upon the application.

The advertiser computer 40 also includes a random access memory device(s) 40B (RAM) and a read only memory device(s) 40C (ROM), each of which is connected to the CPU 40A, a user input device 40D, for entering data and/or commands into the advertiser computer 40, which includes any one or more of a keyboard, a scanner, a user pointing device, such as, for example, a mouse, a touch pad, and/or an audio input device and/or a video input device, etc., if desired, which input device(s) are also connected to the CPU 40A. The advertiser computer 40 also includes a display device 40E for displaying data and/or information to a user or operator.

The advertiser computer 40 also includes a transmitter(s) 40F, for transmitting signals and/or data and/or information to any one or more of the central processing computer(s) 10, the user computers 20, the provider computers 30, the information gathering entity computers 50, and/or any of the other advertiser computers 40, which may be utilized in conjunction with the present invention. The advertiser computer 40 also includes a receiver 40G, for receiving signals and/or data and/or information from any one or more of the central processing computer(s) 10, the user computers 20, the provider computers 30, the information gathering entity computers 50, and/or to any other advertiser computers 40.

The advertiser computer 40 can also include a database(s) 40H which contains data and/or information pertaining to any of the users, operators, providers, advertisers, and information gathering entities, who or which utilize the apparatus and method of the present invention. The database 40H can include any data and/or information needed and/or desired for performing any of the functions and/or services described herein as being provided by the apparatus and method of the present invention. The database 40H can contain any of the data and/or information described herein as being stored and/or utilized by the database 10H of the central processing computer 10.

The database 40H can also contain, for example, name, address, phone number, facsimile number, e-mail address, and/or any other information regarding any of the individuals, users, providers, advertisers, and information gathering entities described herein.

With reference once again to FIG. 5, the advertiser computer 40 also includes an output device 40I such as a printer, a modem, a fax/modem, or other output device, for providing data and/or information to the individual or user of the advertiser computer 40.

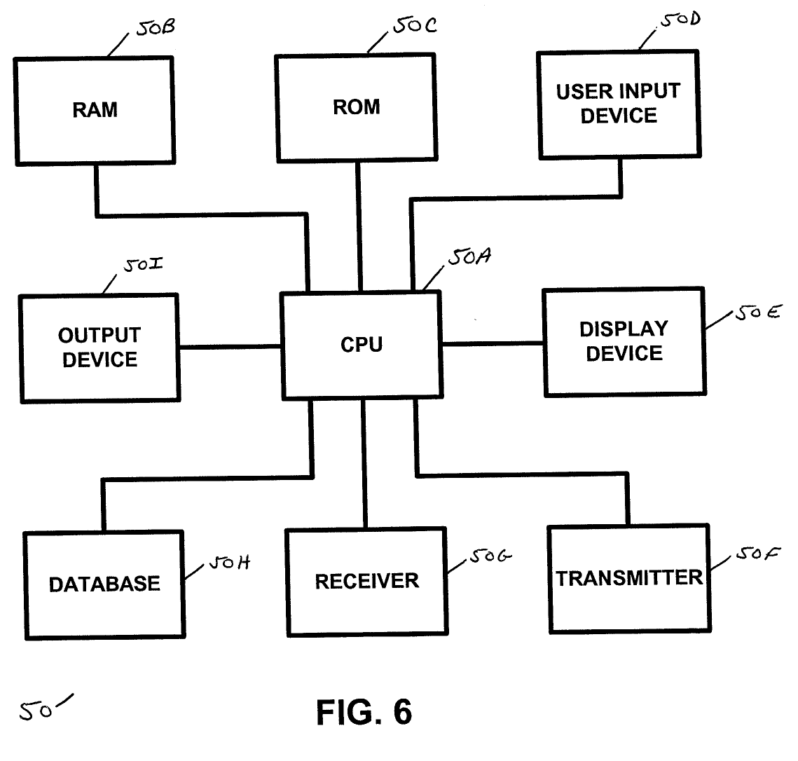

FIG. 6 illustrates the information gathering entity computer 50, in block diagram form. The information gathering entity 50, in the preferred embodiment, is a computer or communication device which can be utilized as an information gathering entity computer. In the preferred embodiment, the information gathering entity computer 50 includes a central processing unit or CPU 50A, which in the preferred embodiment, is a microprocessor. The CPU 50A may also be a microcomputer, a minicomputer, a macro-computer, and/or a mainframe computer, depending upon the application.

The information gathering entity computer 50 also includes a random access memory device(s) 50B (RAM) and a read only memory device(s) 50C (ROM), each of which is connected to the CPU 50A, a user input device 50D, for entering data and/or commands into the information gathering entity computer 50, which includes any one or more of a keyboard, a scanner, a user pointing device, such as, for example, a mouse, a touch pad, and/or an audio input device and/or a video input device, etc., if desired, which input device(s) are also connected to the CPU 50A. The information gathering entity computer 50 also includes a display device 50E for displaying data and/or information to a user or operator.

The information gathering entity computer 50 also includes a transmitter(s) 50F, for transmitting signals and/or data and/or information to any one or more of the central processing computer(s) 10, the user computers 20, the provider computers 30, the advertiser computers 40 and/or any of the other information gathering entity computers 50, which may be utilized in conjunction with the present invention. The information gathering entity computer 50 also includes a receiver 50G, for receiving signals and/or data and/or information from any one or more of the central processing computer(s) 10, the user computers 20, the provider computers 30, the advertiser computers 40, and/or any of the other information gathering entity computers 50.

The information gathering entity computer 50 can also include a database(s) 50H which contains data and/or information pertaining to any of the users, operators, providers, advertisers, and information gathering entities, who or which utilize the apparatus and method of the present invention. The database 50H can include any data and/or information needed and/or desired for performing any of the functions and/or services described herein as being provided by the apparatus and method of the present invention. The database 50H can contain any of the data and/or information described herein as being stored and/or utilized by the database 10H of the central processing computer 10.

The database 50H can also contain, for example, name, address, phone number, facsimile number, e-mail address, and/or any other information regarding any of the individuals, users, providers, advertisers, and information gathering entities described herein.

With reference once again to FIG. 6, the information gathering entity computer 50 also includes an output device 50I such as a printer, a modem, a fax/modem, or other output device, for providing data and/or information to the individual or user of the information gathering computer 50.

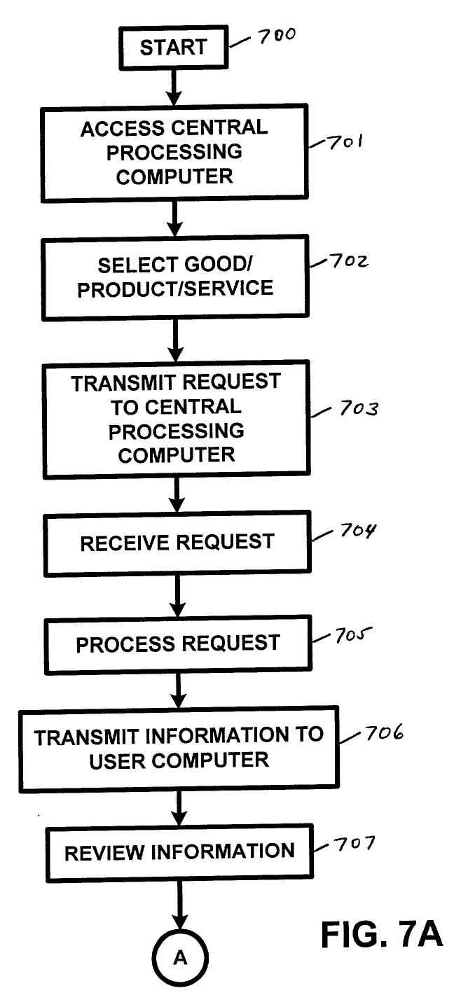

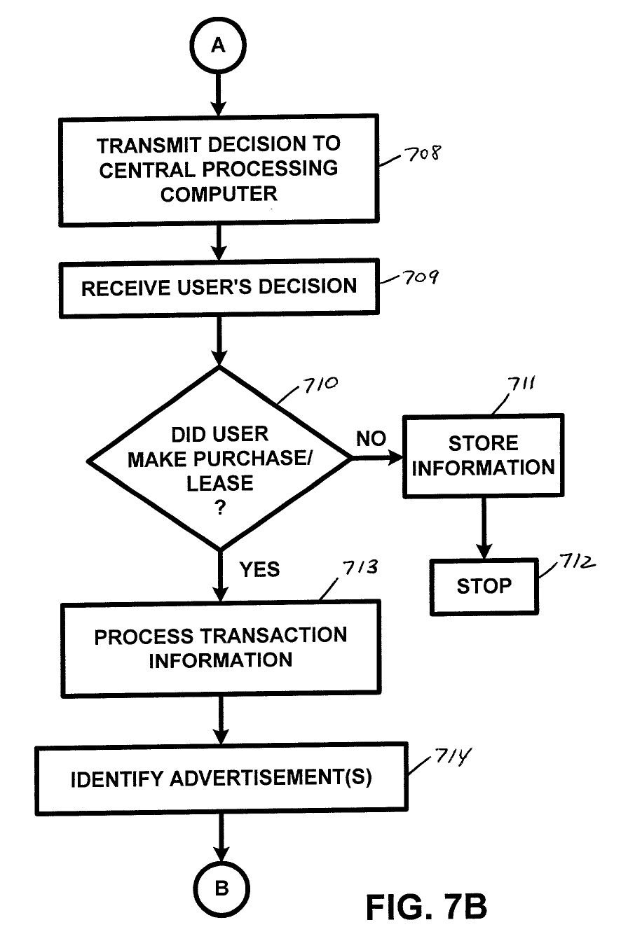

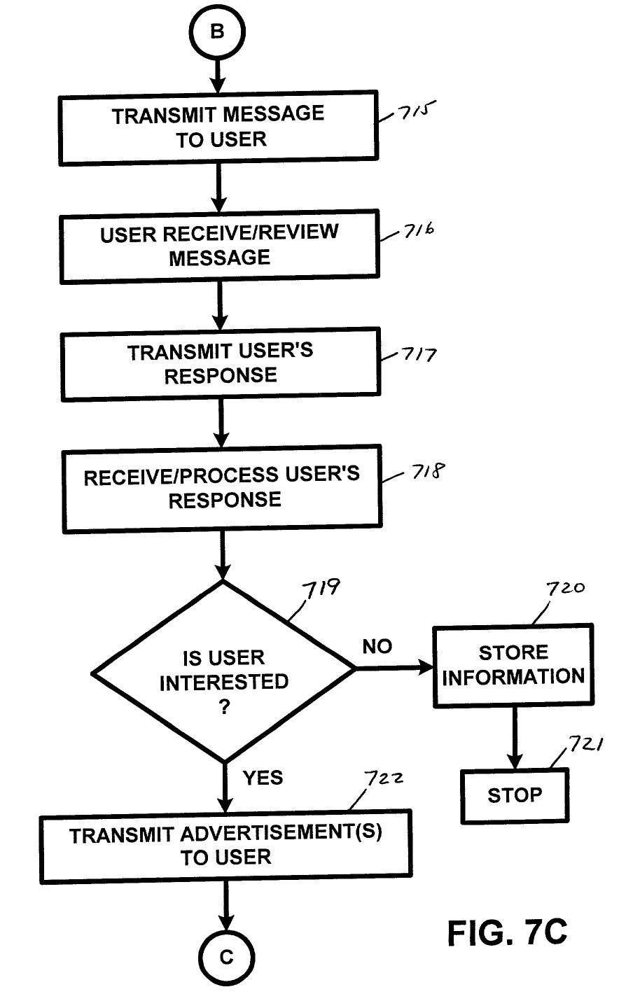

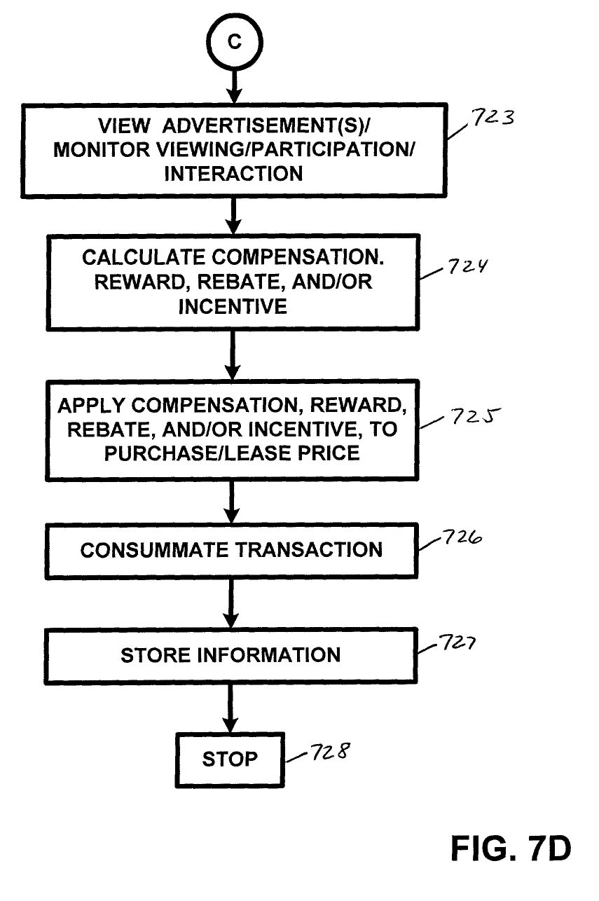

The apparatus and method of the present invention, in a preferred embodiment, can be utilized in order to provide buyers of goods, products, and/or services, with any one or more of compensation, rewards, rebates, and/or incentives, for viewing, reviewing, and/or participating in, advertisements of any type, nature or kind. FIGS. 7A, 7B, 7C and 7D illustrate a method for utilizing the apparatus and method of the present invention, in flow diagram form.

With reference to FIG. 7, the operation of the apparatus and method of the present invention commences at step 700. At step 701, the individual or user can access the central processing computer 10 via the user computer 20. At step 702, the individual or user can select a good, product, and/or service, which he or she is interested in purchasing, leasing, and/or obtaining information about. At step 703, the individual or user can transmit his or her request or selection to the central processing computer 10.

At step 704, the central processing computer 10 can receive the individual's or user's request or selection. At step 705, the central processing computer 10 can process the individual's or user's request or selection and can obtain information regarding the respective goods, products, and/or services, from the database 10H. In another preferred embodiment, the central processing computer can transmit a signal to, and receive any respective information from, a respective provider computer(s) 30. Any of the provider computers 30 can provide or transmit information regarding any of the respective goods, products, and/or services, which are provided by the respective provider(s), to the central processing computer at any time, at specified or random intervals, and/or in any other manner.

The information provided by the providers can include any information related to the offering for sale of, the sale of, a description of, prices of, warranty information for, any of the goods, products, and/or services, provider by the provider. The information provided by the provider can also include any other information and/or data which may be related to the sale of and/or support of any of the goods, products, and/or services, provided by the apparatus and method of the present invention.

With reference once again to FIG. 7, the central processing computer 10 can also, at step 705, identify the good(s), product(s), and/or service(s), which are the subject of the individual's or user's request or selection. At step 706, the central processing computer 10 will transmit the information regarding the requested or selected good(s), product(s), and/or service(s), to the user computer 20. At step 707, the individual or user can review the information and can decide to purchase or lease the respective good(s), product(s), and/or service(s). The individual can purchase or lease the good(s), product(s), and/or service(s), or decide not to purchase or lease same, at step 707. The individual or user can then, at step 708, transmit his or her decision to the central processing computer 10.

At step 709, the central processing computer 10 will receive the individual's or user's decision. At step 710, the central processing computer will determine whether the individual or user has purchased or leased the respective good(s), product(s), and/or service(s).

If, at step 710, it is determined that the individual or user has decided not to purchase or lease any of the goods, products, and/or services, the central processing computer 10 will proceed to step 711 and record or store any and/or all pertinent information regarding the individual or user, the good(s), product(s), and/or service(s), presented the individual or user, the prices, terms and/or conditions, regarding the sale or lease of the good(s), product(s), and/or service(s), provided or offered to the individual or user, and/or the individual's or user's decision not to purchase or lease the respective good(s), product(s), and/or service(s).

The information recorded and/or stored at step 711, can be stored in the database 10H and can be accessed by any of the user computers 20, provider computers 30, advertiser computers 40, and/or information gathering entity computers 50, and/or any of the other central processing computers 10, described herein. Thereafter, the operation of the apparatus 100 ceases at step 712.

If, at step 710, it is determined that the individual or user has decided to purchase or lease a respective good(s), product(s), and/or service(s), then the central processing computer 10 will proceed to step 713 and process the information regarding the transaction. At step 714, the central processing computer 10 can identify an advertisement and/or a plurality of advertisements which can be offered to the individual or user for the individual's or user's viewing, participation and/or feedback.

The advertisements can be selected from the database 10H, and/or can be provided from a respective advertiser computer 40 to the database 10H. In the preferred embodiment, the advertisements can be stored in the database 10H. Information and/or data for selecting advertisements in response to a purchase or lease can also be stored in the database 10H.

The advertisement(s) can be selected based upon any relation and/or correlation of the advertisement(s) to the profile of the individual or user (which can be stored previously), by individual or user sex, age, residence, citizenship, background, ethnic background, purchasing history, leasing history, income, spending habits, spending patterns, buying habits, buying patterns, leasing habits, leasing patterns, previously purchased goods, products, and/or services, past responses to advertisements, past compensation, rewards, rebates, and/or incentives, earned, and/or any other information and/or data which can be utilized in identifying advertisements to provide to the individual or user.

In another preferred embodiment, the central processing computer 10 can transmit a signal to the advertiser computer 40 notifying the advertiser computer 40 of the individual's or user's purchase or lease. The advertiser computer 40 can then select and transmit a desired advertisement to the central processing computer 10 for later transmission to the user computer 20.

At step 715, the central processing computer 10 will transmit a message to the user computer 20 of the individual or user. The message can contain the advertisement(s) identified by the central processing computer 10 along with the compensation, rewards, rebates, and/or incentives, associated and/or corresponding to each of advertisement(s). At step 716, the individual or user can review the message and decide whether he or she desires to view, review, and/or participate in, the advertisement(s).

At step 717, the user computer will transmit the individual's or user's response to the central processing computer 10. The central processing computer will, at step 718, receive and process the individual's or user's response. At step 719, the central processing computer 10 will determine if the individual or user is interested in viewing, reviewing, and/or participating in, the advertisement. If, at step 719, it is determined that the individual or user in not interested in receiving the advertisement information, the central processing computer will proceed to step 720 and record and store the information regarding the purchase or lease and the advertisements offered to, and declined by, the individual or user.

The information recorded or stored, at step 720, can be stored in the database 10H and can be accessed by any of the user computers 20, the provider computers 30, the advertiser computers 40, the information gathering entity computers 50, and/or any of the other central processing computers 10. Thereafter, the operation of the apparatus will cease at step 721.

If, at step 719, it is determined that the individual or user is interested in receiving the advertisement(s) information, the central processing computer will proceed to step 722 and will transmit the advertisement and/or advertisements to the user computer. At step 723, the individual or user can view the advertisement(s), review the advertisement(s), and/or participate and/or interact, with the advertisement(s).

The advertisements provided to the individual or user can be text advertisements, graphical advertisements, video advertisements, audio advertisements, and/or audio-visual advertisements, and/or any combination of same. The advertisement or advertisements can also include or contain a survey(s), a poll(s), and/or a questionnaire(s). The advertisement or advertisements can also include or contain multiple advertisements and/or advertisements for a any type and/or number or combination of goods, products, services, and/or subject matter or issues.

The survey(s), a poll(s), and/or a questionnaire(s), can include or contain any number of survey(s), a poll(s), and/or a questionnaire(s), and/or survey(s), a poll(s), and/or a questionnaire(s), relating to a plurality of subject areas and/or issues. The advertisements can be encoded, digitally encoded, numbered, page numbered, frame numbered, time marked, and/or otherwise marked, encoded, and/or numbered so as to monitor the amount of the advertisement viewed or reviewed by the individual or user.

The advertisement(s) can also include links, hyperlinks, questionnaires, dialog boxes, and/or any other interactive mechanism or means for allowing the individual to participate in and/or interact with the advertisement.

Applicant hereby incorporates by reference herein the subject matter and teachings of U.S. Pat. No. 5,969,714 which teaches an interactive video system with frame reference number. Applicant also hereby incorporates by reference herein the subject matter and teachings of U.S. Pat. No. 5,855,008 which teaches an attention brokerage. Applicant also hereby incorporates by reference herein the subject matter and teachings of U.S. Pat. No. 5,794,210 which teaches an attention brokerage.

At step 723, the central processing computer 10 will monitor the individual's or user's viewing, reviewing, and/or participation in and/or interaction with the advertisement(s). At step 723, any and/or all advertisements can be provided to the individual or user. The individual or user can stop, cancel and/or delete any advertisement(s). The individual or user can also replay and/or repeat any advertisement(s). Compensation, rewards, rebates, and/or incentives, can be provided for replaying and/or repeating advertisements at the advertisers discretion. Any and/or all advertisements will be provided to the individual or user at step 723.

The central processing computer 10 can monitor the provider's viewing, reviewing, participation in and/or interaction with, the advertisement(s) during step 723 and/or at the completion of step 723. The central processing computer 10 can also monitor provider activity in real-time, in a time-delayed manner, in a deferred manner, and/or in any other appropriate manner. Upon the completion of step 723, the central processing computer 10 will proceed to step 724.

At step 724, the central processing computer will calculate the compensation, reward(s), rebate(s), and/or incentive(s), earned by the individual or user at step 723. The compensation, reward, rebate, and/or incentive, can be determined by what the advertiser or advertisers has previously decided to provide to the individual or user for the viewing of, the reviewing of, the participation in and/or the interaction with, the advertisement(s).

Compensation, rewards, rebates, and/or incentives, can be provided for viewing, reviewing, participating in and/or interacting with, the entire advertisements and/or any portions thereof. Compensation, rewards, rebates, and/or incentives, can be fixed in nature, variable in nature, and/or of a hybrid of a fixed and a variable nature. Compensation, rewards, rebates, and/or incentives, can be also be randomly determined by the central processing computer 10 and/or by the respective advertiser or advertiser computer 40.

Compensation, rewards, rebates, and/or incentives, can be determined in any appropriate manner, including, but not limited to, a fixed compensation amount for viewing, reviewing, participating in and/or interacting with the entire advertisement, a variable amount, a pro rata amount depending upon the amount of the advertisement viewed, reviewed, participated in and/or interacted with, a fixed amount per segment of the advertisement viewed, reviewed, participated in and/or interacted with, a variable amount per segment of the advertisement viewed, reviewed, participated in and/or interacted with, and/or any other appropriate manner for providing compensation, rewards, rebates, and/or incentives pursuant to the present invention.

Compensation, rewards, rebates, and/or incentives, can also be determined on a case-by-case basis, on a good, product, and/or service basis, and/or can be determined by any other method such as, but not limited to, time-related factors, seasonal-related factors, economic environment-related factors, and/or any other suitable factors. At step 724, the central processing computer 10 can determine the total compensation, reward, rebate, and/or incentives, earned by the individual or user.

At step 725, the total compensation, reward, rebate, and/or incentive, earned by the individual or user is applied to the selling price or the leasing price of the respective good(s), product(s), and/or service(s), which are being purchased or leased by the individual. In the preferred embodiment, the respective compensation, reward, rebate, and/or incentive, can take the form of a price reduction or savings which is applied directly to the selling or leasing price. In this manner, the respective compensation, reward, rebate, and/or incentive, results in a price reduction and/or savings which can be immediately utilized by the individual or user.

In another preferred embodiment, the respective compensation, reward, rebate, and/or incentive, can be utilized and/or applied to a contemporaneous purchase or lease by the individual or user and/or can be transferred to, and be utilized by, a third party individual or user designated by the individual or user. In another preferred embodiment, the respective compensation, reward, rebate, and/or incentive, can also be utilized wholly and/or in part.

In another preferred embodiment, the respective compensation, reward, rebate, and/or incentive, can be wholly or partly stored in an account set up for the individual or user with information and/or data regarding the account being maintained at the central processing computer 10 and/or the respective user computer 20 and/or any of the other computers 30, 40 and/or 50, described herein.

At step 726, the transaction between the individual or user and the central processing computer is consummated with the individual or user making payment via any appropriate method of means.

At step 727, any information regarding the individual, the goods, products, and/or services which are the subject of the transaction, the advertisement or advertisements which the individual or user viewed, reviewed, participated in and/or interacted with, the respective compensation, reward, rebate, and/or incentive, earned, as well as the final selling prices or leasing prices, and any transfer or storage of the respective compensation, rewards, rebates, and/or incentives, by the individual or user, are recorded and stored in the database 10H. The information stored, at step 727, can be accessed by any of the user computers 20, provider computers 30, advertiser computers 40, information gathering entity computers 50, and/or any other central processing computer(s) 10. Thereafter, the operation of the apparatus 100 will cease at step 728.

In this manner, the apparatus and method of the present invention can provide for compensation, a reward, a rebate, and/or incentives, for viewing, reviewing, an/or participating in and/or interactive with, advertisements, with the respective compensation, reward, rebate, and/or incentive, being applied reduce a purchase price or lease price, in an immediate, contemporaneous, simultaneous, and/or concurrent manner.

The apparatus and method of the present invention can provide for an immediate application of compensation, a reward, a rebate, and/or an incentive, to a purchase price or lease price. The apparatus and method of the present invention can also provide for a deferred use or application of compensation, a reward, a rebate, and/or an incentive, to a purchase price or lease price for a non-contemporaneous or non-concurrent purchase or lease transaction.

In another preferred embodiment, the advertisements can be advertisements for goods, products, services, political advertisements, public service advertisements, industry advertisements, trade group advertisements, and/or any other type of advertisements.

In another preferred embodiment, the central processing computer 10 can determine the advertisement or advertisements to be offered and/or provided to the individual or user by utilizing profile information, market research information, statistical information, and/or historical information, stored in the database 10H and/or provided by any the providers, advertisers, and/or information gathering entities, and/or their respective computers 30, 40, and/or 50.

In another preferred embodiment, the compensation, rewards, rebates, and/or incentives, can take the form of direct price reductions, rebate checks, frequent flier rewards, financial rewards, digital money, coins, and/or tokens, coupons and/or electronic coupons for later purchases or leases of the same goods, products, and/or services, related goods, products, and/or services, and/or unrelated goods, products, and/or services.

In another preferred embodiment, the advertisements can be provided to the individual or user, and the resulting compensation, rewards, rebates, and/or incentives, can be determined, prior to the individual or user making the decision to purchase or lease the good(s), product(s), and/or service(s). In another preferred embodiment, the advertisements can be provided to the individual or user prior to the individual or user making the decision to purchase or lease the good(s), product(s), and/or service(s), and the resulting compensation, rewards, rebates, and/or incentives, can be determined afterwards and prior to completing the transaction.

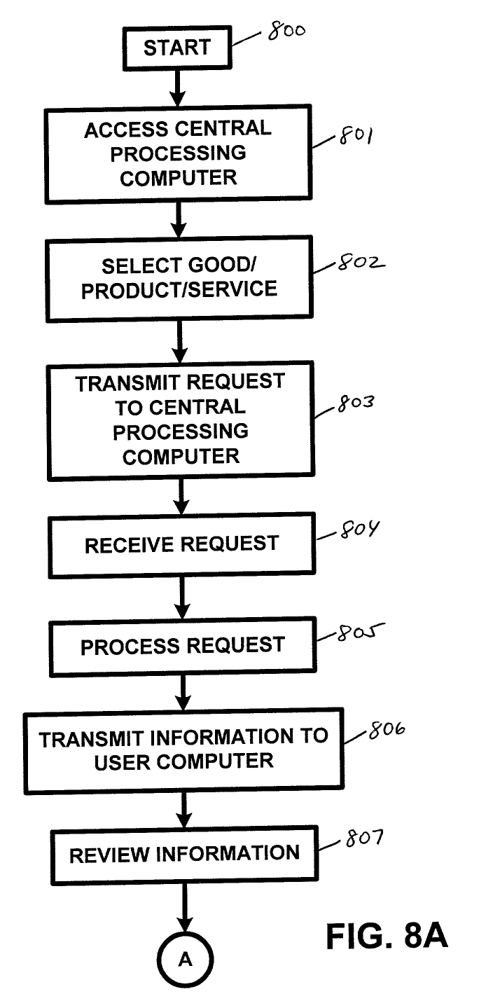

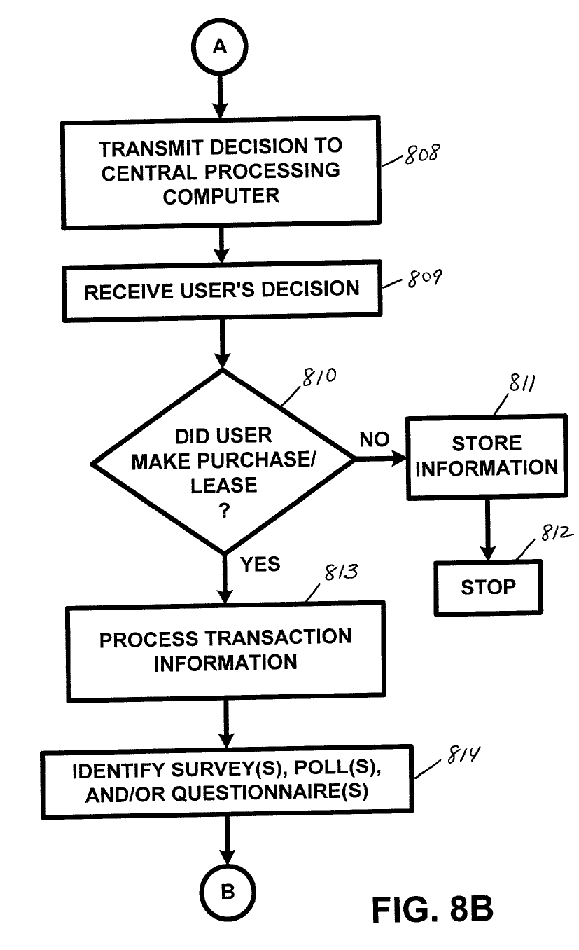

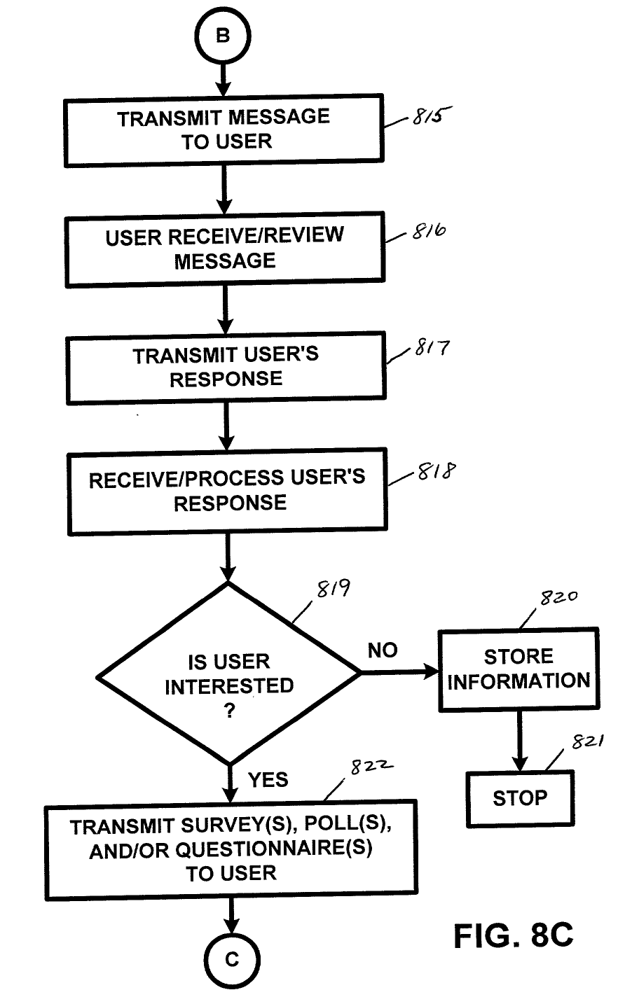

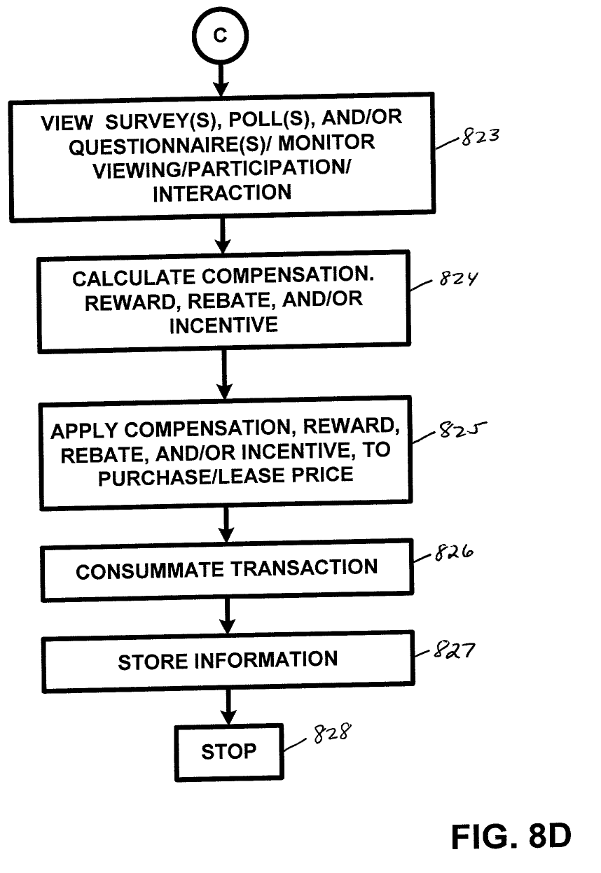

The apparatus and method of the present invention, in a preferred embodiment, can be utilized in order to provide buyers of goods, products, and/or services, with any one or more of compensation, rewards, rebates, and/or incentives, for viewing, reviewing, and/or participating in, surveys, polls, and/or questionnaires, of any type, nature or kind. FIGS. 8A, 8B, 8C and 8D illustrate a method for utilizing the apparatus and method of the present invention, in flow diagram form. For simplicity, the embodiment of FIG. 8 may be described as being utilized in conjunction with surveys although it is to be easily understood that the embodiment of FIG. 8 can be utilized with any surveys, polls, polling efforts, and/or questionnaires. Further, the terms “survey”. “poll”, “polling effort” and “questionnaires” can be synonymous with each other as these terms are used herein.

With reference to FIG. 8, the operation of the apparatus and method of the present invention commences at step 800. At step 801, the individual or user can access the central processing computer 10 via the user computer 20. At step 802, the individual or user can select a good, product, and/or service, which he or she is interested in purchasing, leasing, and/or obtaining information about. At step 803, the individual or user can transmit his or her request or selection to the central processing computer 10.

At step 804, the central processing computer 10 can receive the individual's or user's request or selection. At step 805, the central processing computer 10 can process the individual's or user's request or selection and can obtain information regarding the respective goods, products, and/or services, from the database 10H. In another preferred embodiment, the central processing computer can transmit a signal to, and receive any respective information from, a respective provider computer(s) 30. Any of the provider computers 30 can provide or transmit information regarding any of the respective goods, products, and/or services, which are provided by the respective provider(s), to the central processing computer at any time, at specified or random intervals, and/or in any other manner.

The information provided by the providers can include any information related to the offering for sale of, the sale of, a description of, prices of, warranty information for, any of the goods, products, and/or services, provider by the provider. The information provided by the provider can also include any other information and/or data which may be related to the sale of and/or support of any of the goods, products, and/or services, provided by the apparatus and method of the present invention.

With reference once again to FIG. 8, the central processing computer 10 can also, at step 805, identify the good(s), product(s), and/or service(s), which are the subject of the individual's or user's request or selection. At step 806, the central processing computer 10 will transmit the information regarding the requested or selected good(s), product(s), and/or service(s), to the user computer 20. At step 807, the individual or user can review the information and can decide to purchase or lease the respective good(s), product(s), and/or service(s). The individual can purchase or lease the good(s), product(s), and/or service(s), or decide not to purchase or lease same, at step 807. The individual or user can then, at step 808, transmit his or her decision to the central processing computer 10.

At step 809, the central processing computer 10 will receive the individual's or user's decision. At step 810, the central processing computer will determine whether the individual or user has purchased or leased the respective good(s), product(s), and/or service(s).

If, at step 810, it is determined that the individual or user has decided not to purchase or lease any of the goods, products, and/or services, the central processing computer 10 will proceed to step 811 and record or store any and/or all pertinent information regarding the individual or user, the good(s), product(s), and/or service(s), presented the individual or user, the prices, terms and/or conditions, regarding the sale or lease of the good(s), product(s), and/or service(s), provided or offered to the individual or user, and/or the individual's or user's decision not to purchase or lease the respective good(s), product(s), and/or service(s).

The information recorded and/or stored at step 811, can be stored in the database 10H and can be accessed by any of the user computers 20, provider computers 30, advertiser computers 40, and/or information gathering entity computers 50, and/or any of the other central processing computers 10, described herein. Thereafter, the operation of the apparatus 100 ceases at step 812.

If, at step 810, it is determined that the individual or user has decided to purchase or lease a respective good(s), product(s), and/or service(s), then the central processing computer 10 will proceed to step 813 and process the information regarding the transaction. At step 814, the central processing computer 10 can identify a survey, poll, and/or questionnaire, and/or a plurality of surveys, polls, and/or questionnaires, which can be offered to the individual or user for the individual's or user's viewing, participation and/or feedback.

The surveys, polls, and/or questionnaires, can be selected from the database 10H, and/or can be provided from a respective information gathering entity computer 50 to the database 10H. In the preferred embodiment, the surveys, polls, and/or questionnaires, can be stored in the database 10H. Information and/or data for selecting surveys, polls, and/or questionnaires, in response to a purchase or lease can also be stored in the database 10H. The surveys, polls, and/or questionnaires, can be selected based upon any relation and/or correlation of the surveys, polls, and/or questionnaires, to the profile of the individual or user (which can be stored previously), by individual or user sex, age, residence, citizenship, background, ethnic background, purchasing history, leasing history, income, spending habits, spending patterns, buying habits, buying patterns, leasing habits, leasing patterns, previously purchased goods, products, and/or services, past responses to surveys, polls, and/or questionnaires, past compensation, rewards, rebates, and/or incentives, earned, and/or any other information and/or data which can be utilized in identifying surveys, polls, and/or questionnaires to provide to the individual or user.

In another preferred embodiment, the central processing computer 10 can transmit a signal to the information gathering entity computer 50 notifying the information gathering entity computer 50 of the individual's or user's purchase or lease. The information gathering entity computer 50 can then select and transmit a desired survey(s), poll(s), and/or questionnaire(s), to the central processing computer 10 for later transmission to the user computer 20.

At step 815, the central processing computer 10 will transmit a message to the user computer 20 of the individual or user. The message can contain the survey(s), poll(s), and/or questionnaire(s), identified by the central processing computer 10 along with the compensation, rewards, rebates, and/or incentives, associated and/or corresponding to each of survey(s), poll(s), and/or questionnaire(s). At step 816, the individual or user can review the message and decide whether he or she desires to view, review, and/or participate in, the survey(s), poll(s), and/or questionnaire(s).

At step 817, the user computer will transmit the individual's or user's response to the central processing computer 10. The central processing computer will, at step 818, receive and process the individual's or user's response. At step 819, the central processing computer 10 will determine if the individual or user is interested in viewing, reviewing, and/or participating in, the survey(s), poll(s), and/or questionnaire(s). If, at step 819, it is determined that the individual or user in not interested in receiving the survey(s), poll(s), and/or questionnaire(s), information, the central processing computer will proceed to step 820 and record and store the information regarding the purchase or lease and the survey(s), poll(s), and/or questionnaire(s), offered to, and declined by, the individual or user.

The information recorded or stored, at step 820, can be stored in the database 10H and can be accessed by any of the user computers 20, the provider computers 30, the advertiser computers 40, the information gathering entity computers 50, and/or any of the other central processing computers 10. Thereafter, the operation of the apparatus will cease at step 821.

If, at step 819, it is determined that the individual or user is interested in receiving the survey(s), poll(s), and/or questionnaire(s), information, the central processing computer will proceed to step 822 and will transmit the survey(s), poll(s), and/or questionnaire(s), to the user computer. At step 823, the individual or user can view the survey(s), poll(s), and/or questionnaire(s), review the survey(s), poll(s), and/or questionnaire(s), and/or participate and/or interact, with the survey(s), poll(s), and/or questionnaire(s). The survey(s), poll(s), and/or questionnaire(s), provided to the individual or user can be text survey(s), poll(s), and/or questionnaire(s), graphical survey(s), poll(s), and/or questionnaire(s), video survey(s), poll(s), and/or questionnaire(s), audio survey(s), poll(s), and/or questionnaire(s), and/or audio-visual survey(s), poll(s), and/or questionnaire(s), and/or any combination of same.

The survey(s), poll(s), and/or a questionnaire(s) can also include or contain an advertisement or advertisements. The survey(s), poll(s), and/or a questionnaire(s) can also include or contain multiple survey(s), a poll(s), and/or a questionnaire(s) for any number and/or combination of goods, products, services, subject areas, and/or issues. The survey(s), a poll(s), and/or a questionnaire(s), can include or contain any number of advertisements for any type and/or number or combination of goods, products, services, and/or any other subject matter or issues. The survey(s), poll(s), and/or questionnaire(s), can be encoded, digitally encoded, numbered, page numbered, frame numbered, time marked, and/or otherwise marked, encoded, and/or numbered so as to monitor the amount of the survey(s), poll(s), and/or questionnaire(s), viewed or reviewed by the individual or user.

The survey(s), poll(s), and/or questionnaire(s), can also include links, hyperlinks, questionnaires, dialog boxes, and/or any other interactive mechanism or means for allowing the individual to participate in and/or interact with the survey(s), poll(s), and/or questionnaire(s).

At step 823, the central processing computer 10 will monitor the individual's or user's viewing, reviewing, and/or participation in and/or interaction with the survey(s), poll(s), and/or questionnaire(s). At step 823, any and/or all survey(s), poll(s), and/or questionnaire(s), can be provided to the individual or user. The individual or user can stop, cancel and/or delete any survey(s), poll(s), and/or questionnaire(s). The individual or user can also replay and/or repeat any survey(s), poll(s), and/or questionnaire(s).

Compensation, rewards, rebates, and/or incentives, can be provided for replaying and/or repeating survey(s), poll(s), and/or questionnaire(s), if appropriate and/or at the information gathering entity's discretion. Any and/or all survey(s), poll(s), and/or questionnaire(s), will be provided to the individual or user at step 823. The central processing computer 10 can monitor the provider's viewing, reviewing, participation in and/or interaction with, the survey(s), poll(s), and/or questionnaire(s), during step 823 and/or at the completion of step 823. The central processing computer 10 can also monitor provider activity in real-time, in a time-delayed manner, in a deferred manner, and/or in any other appropriate manner. Upon the completion of step 823, the central processing computer 10 will proceed to step 824.

At step 824, the central processing computer will calculate the compensation, reward(s), rebate(s), and/or incentive(s), earned by the individual or user at step 823. The compensation, reward, rebate, and/or incentive, can be determined by what the information gathering entity or information gathering entities has or have previously decided to provide to the individual or user for the viewing of, the reviewing of, the participation in and/or the interaction with, the survey(s), poll(s), and/or questionnaire(s).

Compensation, rewards, rebates, and/or incentives, can be provided for viewing, reviewing, participating in and/or interacting with, the entire survey(s), poll(s), and/or questionnaire(s), and/or any portions thereof. Compensation, rewards, rebates, and/or incentives, can be fixed in nature, variable in nature, and/or of a hybrid of a fixed and a variable nature. Compensation, rewards, rebates, and/or incentives, can be also be randomly determined by the central processing computer 10 and/or by the respective information gathering entity or information gathering entity computer 40.

As noted above, compensation, rewards, rebates, and/or incentives, can be determined in any appropriate manner, including, but not limited to, a fixed compensation amount for viewing, reviewing, participating in and/or interacting with the entire survey, poll, and/or questionnaire, a variable amount, a pro rata amount depending upon the amount of the survey, poll, and/or questionnaire, viewed, reviewed, participated in and/or interacted with, a fixed amount per segment of the survey, poll, and/or questionnaire, viewed, reviewed, participated in and/or interacted with, a variable amount per segment of the survey, poll, and/or questionnaire, viewed, reviewed, participated in and/or interacted with, and/or any other appropriate manner for providing compensation, rewards, rebates, and/or incentives pursuant to the present invention.

Compensation, rewards, rebates, and/or incentives, can also be determined on a case-by-case basis, on a good, product, and/or service basis, and/or can be determined by any other method such as, but not limited to, time-related factors, seasonal-related factors, economic environment-related factors, and/or any other suitable factors. At step 824, the central processing computer 10 can determine the total compensation, reward, rebate, and/or incentives, earned by the individual or user.

At step 825, the total compensation, reward, rebate, and/or incentive, earned by the individual or user is applied to the selling price or the leasing price of the respective good(s), product(s), and/or service(s), which are being purchased or leased by the individual. In the preferred embodiment, the respective compensation, reward, rebate, and/or incentive, can take the form of a price reduction or savings which is applied directly to the selling or leasing price. In this manner, the respective compensation, reward, rebate, and/or incentive, results in a price reduction and/or savings which can be immediately utilized by the individual or user.

In another preferred embodiment, the respective compensation, reward, rebate, and/or incentive, can be utilized and/or applied to a contemporaneous purchase or lease by the individual or user and/or can be transferred to, and be utilized by, a third party individual or user designated by the individual or user. In another preferred embodiment, the respective compensation, reward, rebate, and/or incentive, can also be utilized wholly and/or in part.

In another preferred embodiment, the respective compensation, reward, rebate, and/or incentive, can be wholly or partly stored in an account set up for the individual or user with information and/or data regarding the account being maintained at the central processing computer 10 and/or the respective user computer 20 and/or any of the other computers 30, 40 and/or 50, described herein.

At step 826, the transaction between the individual or user and the central processing computer 10 is consummated with the individual or user making payment via any appropriate method of means.

At step 827, any information regarding the individual, the goods, products, and/or services which are the subject of the transaction, the survey(s), poll(s), and/or questionnaire(s), which the individual or user viewed, reviewed, participated in and/or interacted with, the respective compensation, reward, rebate, and/or incentive, earned, as well as the final selling prices or leasing prices, and any transfer or storage of the respective compensation, rewards, rebates, and/or incentives, by the individual or user, are recorded and stored in the database 10H. The information stored, at step 827, can be accessed by any of the user computers 20, provider computers 30, advertiser computers 40, information gathering entity computers 50, and/or any other central processing computer(s) 10. Thereafter, the operation of the apparatus 100 will cease at step 828.

In this manner, the apparatus and method of the present invention can provide for compensation, a reward, a rebate, and/or incentives, for viewing, reviewing, an/or participating in and/or interactive with, the survey(s), poll(s), and/or questionnaire(s), with the respective compensation, reward, rebate, and/or incentive, being applied reduce a purchase price or lease price, in an immediate, contemporaneous, simultaneous, and/or concurrent manner.

The apparatus and method of the present invention can provide for an immediate application of compensation, a reward, a rebate, and/or an incentive, to a purchase price or lease price. The apparatus and method of the present invention can also provide for a deferred use or application of compensation, a reward, a rebate, and/or an incentive, to a purchase price or lease price for a non-contemporaneous or non-concurrent purchase or lease transaction.

In another preferred embodiment, the survey(s), poll(s), and/or questionnaire(s), can be the survey(s), poll(s), and/or questionnaire(s), for goods, products, services, political issues, public issues, public service issues, issues of any kind, advertisements of any kind, industry advertisements, trade group advertisements, social issues, economic issues, and/or any other surveys, polls, and/or questionnaires for any subject matter and/or subjects or issues for which survey(s), poll(s), and/or questionnaire(s) can or may be utilized.

In another preferred embodiment, the central processing computer 10 can determine the survey(s), poll(s), and/or questionnaire(s) to be offered and/or provided to the individual or user by utilizing profile information, market research information, statistical information, and/or historical information, stored in the database 10H and/or provided by any the providers, advertisers, and/or information gathering entities, and/or their respective computers 30, 40, and/or 50.

In another preferred embodiment, the compensation, rewards, rebates, and/or incentives, can take the form of direct price reductions, rebate checks, frequent flier rewards, financial rewards, digital money, coins, and/or tokens, coupons and/or electronic coupons for later purchases or leases of the same goods, products, and/or services, related goods, products, and/or services, and/or unrelated goods, products, and/or services.

In another preferred embodiment, the survey(s), poll(s), and/or questionnaire(s), can be provided to the individual or user, and the resulting compensation, rewards, rebates, and/or incentives, can be determined, prior to the individual or user making the decision to purchase or lease the good(s), product(s), and/or service(s). In another preferred embodiment, the survey(s), poll(s), and/or questionnaire(s), can be provided to the individual or user prior to the individual or user making the decision to purchase or lease the good(s), product(s), and/or service(s), and the resulting compensation, rewards, rebates, and/or incentives, can be determined afterwards and prior to completing the transaction.

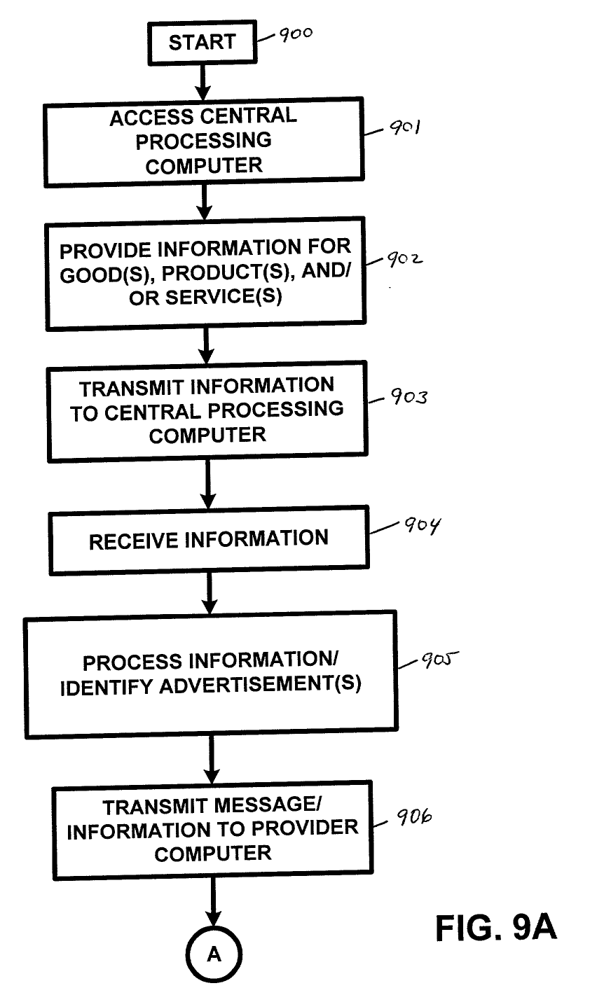

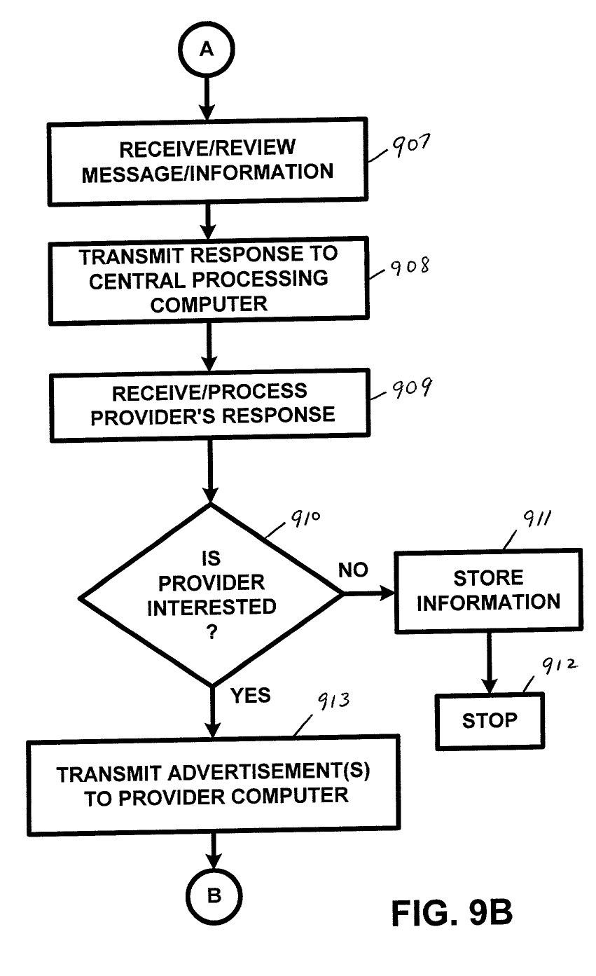

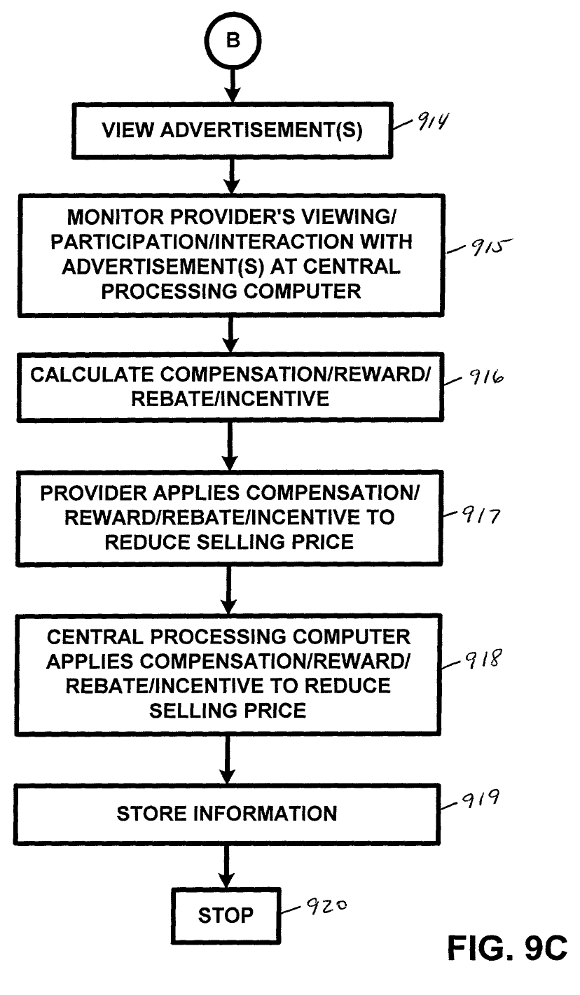

The apparatus and method of the present invention, in a preferred embodiment, can be utilized in order to provide a provider, seller, or lessor, (hereinafter referred to as “provider”) of goods, products, and/or services, with any one or more of compensation, rewards, rebates, and/or incentives, for viewing, reviewing, and/or participating in, advertisements of any type, nature or kind. FIGS. 9A, 9B, and 9C illustrate a method for utilizing the apparatus and method of the present invention, in flow diagram form.

With reference to FIG. 9, the operation of the apparatus and method of the present invention commences at step 900. At step 901, the provider can access the central processing computer 10 via the provider computer 30. At step 902, the provider can provide information regarding the good(s), product(s), and/or service(s), which it is interested in selling and/or leasing. The information can include the name, description, price(s), warranty information, and/or any other information about the respective good(s), product(s), and/or service(s) provided for sale or lease by the provider. At step 903, the provider can transmit its information regarding the good(s), product(s), and/or service(s), which it is interested in selling and/or leasing to the central processing computer 10.

At step 904, the central processing computer 10 can receive the provider's information. At step 905, the central processing computer 10 can process the provider's information regarding the respective goods, products, and/or services, from the database 10H. In another preferred embodiment, the central processing computer 10 can transmit a signal to, and receive any other or additional information from any of the respective user computer(s) 20, provider computers 30, advertiser computer(s) 40, and/or an information gathering entity computer 50. Any of the provider computers 30 can provide or transmit information regarding any of the respective goods, products, and/or services, which are provided by the respective provider(s), to the central processing computer 10 at any time, at specified or random intervals, and/or in any other manner.

The information provided by the providers or provider computers 30 can include any information related to the offering for sale of, the sale of, a description of, prices of, warranty information for, any of the goods, products, and/or services, provider by the provider. The information provided by the provider can also include any other information and/or data which may be related to the sale of and/or support of any of the goods, products, and/or services, provided by the apparatus and method of the present invention.

With reference once again to FIG. 9, the central processing computer 10 can also, at step 905, identify an advertisement and/or a plurality of advertisements which can be offered to the provider for the provider's viewing, participation and/or feedback.

The advertisements can be selected from the database 10H, and/or can be provided from a respective advertiser computer 40 to the database 10H. In the preferred embodiment, the advertisements can be stored in the database 10H. Information and/or data for selecting advertisements in response to a posting of goods, products, and/or services, for sale or lease can also be stored in the database 10H.

The advertisement(s) can be selected based upon any relation and/or correlation of the advertisement(s) to the profile of the provider (which can be stored previously), by the nature of the provider's business and/or the goods, products, and/or services, which the provider offers for sale or lease as well as the goods, products, and/or services, which the provider may itself purchase or lease in the course of its business operations and/or other activities. The advertisement(s) can also be selected based upon information regarding the provider's residence, citizenship, background, purchasing history, leasing history, income, profits, spending habits, spending patterns, buying habits, buying patterns, leasing habits, leasing patterns, previously purchased goods, products, and/or services, past responses to advertisements, past compensation, rewards, rebates, and/or incentives, earned, and/or any other information and/or data which can be utilized in identifying advertisements to provide to the provider.

In another preferred embodiment, the central processing computer 10 can transmit a signal to the advertiser computer 40 notifying the advertiser computer 40 of the provider's posting of goods, products, and/or services, for sale or lease and/or the offering of the goods, products, and/or services, for sale or lease. The advertiser computer 40 can then select and transmit a desired advertisement to the central processing computer 10 for later transmission to the provider computer 30.

At step 906, the central processing computer 10 will transmit a message to the provider computer 30 of the provider. The message can contain the advertisement(s) identified by the central processing computer 10 along with the compensation, rewards, rebates, and/or incentives, associated and/or corresponding to each of advertisement(s). At step 907, the provider can review the message and decide whether it desires to view, review, and/or participate in, the advertisement(s).

At step 908, the provider computer 30 will transmit the provider's response to the central processing computer 10. The central processing computer 10 will, at step 909, receive and process the provider's response. At step 910, the central processing computer 10 will determine if the provider is interested in viewing, reviewing, and/or participating in, the advertisement. If, at step 910, it is determined that the provider is not interested in receiving the advertisement information, the central processing computer 10 will proceed to step 911 and record and store the information regarding the posting of the goods, products, and/or services for sale or lease and the advertisements offered to, and declined by, the provider.

The information recorded or stored, at step 911, can be stored in the database 10H and can be accessed by any of the user computers 20, the provider computers 30, the advertiser computers 40, the information gathering entity computers 50, and/or any of the other central processing computers 10. Thereafter, the operation of the apparatus will cease at step 912.

If, at step 910, it is determined that the provider is interested in receiving the advertisement(s) information, the central processing computer will proceed to step 913 and will transmit the advertisement and/or advertisements to the provider computer 30. At step 914, the provider can view the advertisement(s), review the advertisement(s), and/or participate and/or interact, with the advertisement(s). The advertisements provided to the provider can be text advertisements, graphical advertisements, video advertisements, audio advertisements, and/or audio-visual advertisements, and/or any combination of same. The advertisement or advertisements can also include or contain a survey(s), a poll(s), and/or a questionnaire(s).

The advertisement or advertisements can also include or contain multiple advertisements and/or advertisements for any type and/or number or combination of goods, products, services, and/or subject matter or issues. The survey(s), a poll(s), and/or a questionnaire(s), can include or contain any number of survey(s), a poll(s), and/or a questionnaire(s), and/or survey(s), a poll(s), and/or a questionnaire(s), relating to a plurality of subject areas and/or issues. The advertisements can be encoded, digitally encoded, numbered, page numbered, frame numbered, time marked, and/or otherwise marked, encoded, and/or numbered so as to monitor the amount of the advertisement viewed or reviewed by the provider. The advertisement(s) can also include links, hyperlinks, questionnaires, dialog boxes, and/or any other interactive mechanism or means for allowing the provider to participate in and/or interact with the advertisement. At step 914, any and/or all advertisements can be provided to the provider.

At step 915, the central processing computer 10 will monitor the provider's viewing, reviewing, and/or participation in and/or interaction with the advertisement(s). The provider can stop, cancel and/or delete, any advertisement(s). The provider can also replay and/or repeat any advertisement(s). Compensation, rewards, rebates, and/or incentives, can be provided for replaying and/or repeating advertisements at the advertisers discretion. Any and/or all advertisements can be monitored at step 915.

The central processing computer 10 can monitor the provider's viewing, reviewing, participation in and/or interaction with, the advertisement(s) during step 915 and/or at the completion of step 915. The central processing computer 10 can also monitor provider activity in real-time, in a time-delayed manner, in a deferred manner, and/or in any other appropriate manner. Upon the completion of step 915, the central processing computer 10 will proceed to step 916.

At step 916, the central processing computer 10 will calculate the compensation, reward(s), rebate(s), and/or incentive(s), earned by the provider at step 914 and/or at step 915. The compensation, reward, rebate, and/or incentive, can be determined by what the advertiser or advertisers has previously decided to provide to the provider for the viewing of, the reviewing of, the participation in and/or the interaction with, the advertisement(s).

Compensation, rewards, rebates, and/or incentives, can be provided for viewing, reviewing, participating in and/or interacting with, the entire advertisements and/or any portions thereof. Compensation, rewards, rebates, and/or incentives, can be fixed in nature, variable in nature, and/or of a hybrid of a fixed and a variable nature. Compensation, rewards, rebates, and/or incentives, can be also be randomly determined by the central processing computer 10 and/or by the respective advertiser or advertiser computer 40.

Compensation, rewards, rebates, and/or incentives, can be determined in any appropriate manner, including, but not limited to, a fixed compensation amount for viewing, reviewing, participating in and/or interacting with the entire advertisement, a variable amount, a pro rata amount depending upon the amount of the advertisement viewed, reviewed, participated in and/or interacted with, a fixed amount per segment of the advertisement viewed, reviewed, participated in and/or interacted with, a variable amount per segment of the advertisement viewed, reviewed, participated in and/or interacted with, and/or any other appropriate manner for providing compensation, rewards, rebates, and/or incentives pursuant to the present invention.

Compensation, rewards, rebates, and/or incentives, can be provided for viewing, reviewing, participating in and/or interacting with, the entire advertisements and/or any portions thereof. Compensation, rewards, rebates, and/or incentives, can be fixed in nature, variable in nature, and/or of a hybrid of a fixed and a variable nature. Compensation, rewards, rebates, and/or incentives, can be also be randomly determined by the central processing computer 10 and/or by the respective advertiser or advertiser computer 40.

Compensation, rewards, rebates, and/or incentives, can also be determined on a case-by-case basis, on an advertisement basis, an advertisement-by-advertisement basis, and/or can be determined by any other method such as, but not limited to, time-related factors, seasonal-related factors, economic environment-related factors, and/or any other suitable factors. At step 916, the central processing computer 10 can determine the total compensation, reward, rebate, and/or incentives, earned by the provider.

At step 917, the total compensation, reward, rebate, and/or incentive, earned by the provider can then be applied, by the provider, to reduce the selling or leasing price of the goods, products, and/or services, offered for sale or lease by the provider, to a provider spending account, and/or as a direct payment to the provider.

In the preferred embodiment, the respective compensation, reward, rebate, and/or incentive, can take the form of a price reduction or savings which is applied directly to the selling or leasing price. In this manner, the respective compensation, reward, rebate, and/or incentive, results in a price reduction and/or savings which can be immediately utilized to enhance the provider's offering(s). In another preferred embodiment, the provider can apply the respective compensation, reward, rebate, and/or incentive, towards a sweepstakes prize offered to its customers or potential customers. In another preferred embodiment, the respective compensation, reward, rebate, and/or incentive, can be applied by the provider to obtain a price reduction for any purchase or lease which it desires to make as a consumer.

In another preferred embodiment, the respective compensation, reward, rebate, and/or incentive, can be applied to a savings account for later use by the provider to make purchases for itself and/or make price reductions for later offerings. In another preferred embodiment, the provider can apportion the respective compensation, rewards, rebates, and/or incentives, among any one or more of the herein-described uses.

In another preferred embodiment, the respective compensation, reward, rebate, and/or incentive, can be utilized and/or applied to a contemporaneous purchase or lease by the provider and/or can be transferred to, and be utilized by, a third party individual or user designated by the provider. In another preferred embodiment, the respective compensation, reward, rebate, and/or incentive, can also be utilized wholly and/or in part.

In another preferred embodiment, the respective compensation, reward, rebate, and/or incentive, can be wholly or partly stored in an account set up for the provider with information and/or data regarding the account being maintained at the central processing computer 10 and/or the respective provider computer 30 and/or any of the other computers 10, 20, 40 and/or 50, described herein.

At step 918, the central processing computer 10 will apply the respective compensation, rewards, rebates, and/or incentives in the manner directed by the provider. At step 919, the central processing computer 10 will record and store the information regarding the posting of the goods, products, and/or services for sale or lease and the advertisements offered to, accepted by, and/or declined by, the provider. The information recorded or stored, at step 919, can be stored in the database 10H and can be accessed by any of the user computers 20, the provider computers 30, the advertiser computers 40, the information gathering entity computers 50, and/or any of the other central processing computers 10.

At step 919, any information regarding the provider, the goods, products, and/or services which are the subject of the posting of offering, the advertisement or advertisements which the provider viewed, reviewed, participated in and/or interacted with, the respective compensation, reward, rebate, and/or incentive, earned, as well as how and in what manner and/or manners the respective compensation, rewards, rebates, and/or incentives, were utilized and/or applied, including reductions of the final selling prices or leasing prices, any direct or indirect use of the respective compensation, rewards, rebates, and/or incentives, and/or any transfer or storage of same, by the provider, are recorded and stored in the database 10H. Thereafter, the operation of the apparatus 100 will cease at step 920.

In this manner, the apparatus and method of the present invention can provide for compensation, a reward, a rebate, and/or incentives, for viewing, reviewing, an/or participating in and/or interacting with, advertisements, with the respective compensation, reward, rebate, and/or incentive, being applied reduce a selling price or leasing price, in an immediate, contemporaneous, simultaneous, and/or concurrent manner.

The apparatus and method of the present invention can provide for an immediate application of compensation, a reward, a rebate, and/or an incentive, to a purchase price or lease price. The apparatus and method of the present price or invention can also provide for a deferred use or application of compensation, a reward, a rebate, and/or an incentive, to a selling leasing price for a non-contemporaneous or non-concurrent purchase or lease transaction.

In another preferred embodiment, the advertisements can be advertisements for goods, products, services, political advertisements, public service advertisements, industry advertisements, trade group advertisements, and/or any other type of advertisements.

In another preferred embodiment, the central processing computer 10 can determine the advertisement or advertisements to be offered and/or provided to the provider by utilizing profile information, market research information, statistical information and/or historical information, stored in the database 10H and/or provided by any the individuals or users, providers, advertisers, and/or information gathering entities, and/or their respective computers 10, 20, 30, 40, and/or 50.

In another preferred embodiment, the compensation, rewards, rebates, and/or incentives, can take the form of direct price reductions, rebate checks, frequent flier rewards, financial rewards, digital money, coins, and/or tokens, coupons and/or electronic coupons for later purchases or leases of the same goods, products, and/or services, related goods, products, and/or services, and/or unrelated goods, products, and/or services.

In another preferred embodiment, the advertisements can be provided to the provider, and the resulting compensation, rewards, rebates, and/or incentives, can be determined, prior to the provider making the decision to post or offer the good(s), product(s), and/or service(s) for sale or lease. In another preferred embodiment, the advertisements can be provided to the provider prior to the provider making the decision to offer to sell or lease the good(s), product(s), and/or service(s), and the resulting compensation, rewards, rebates, and/or incentives, can be determined afterwards and prior to completing the posting or offering.

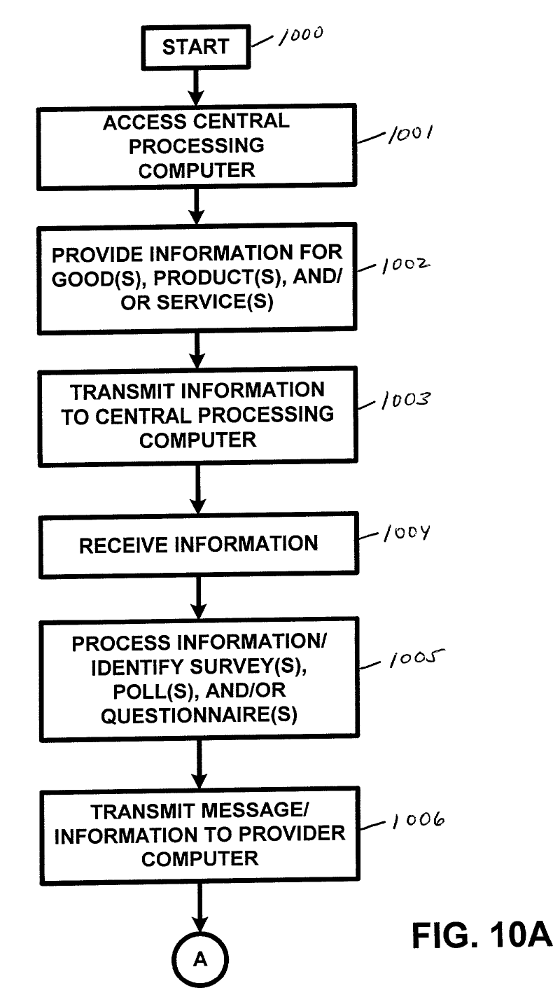

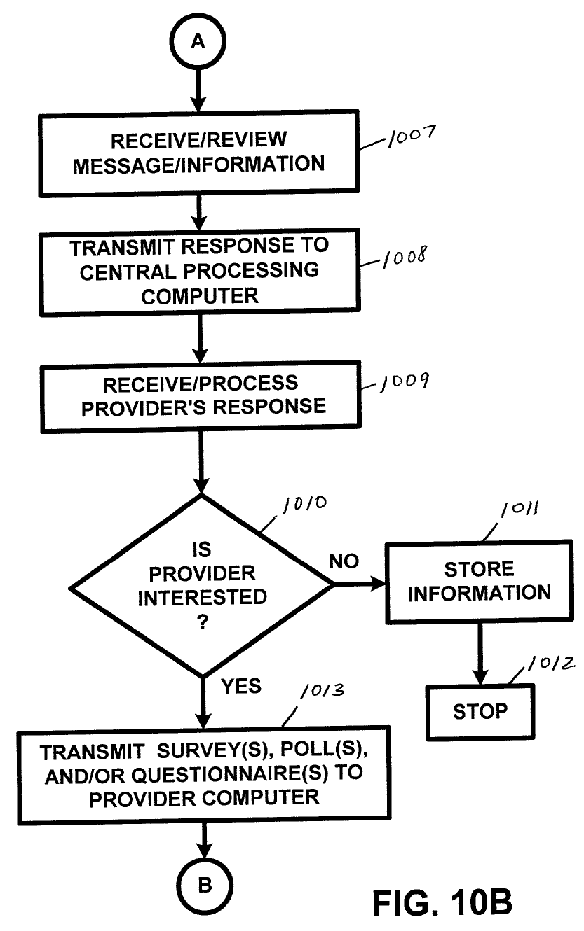

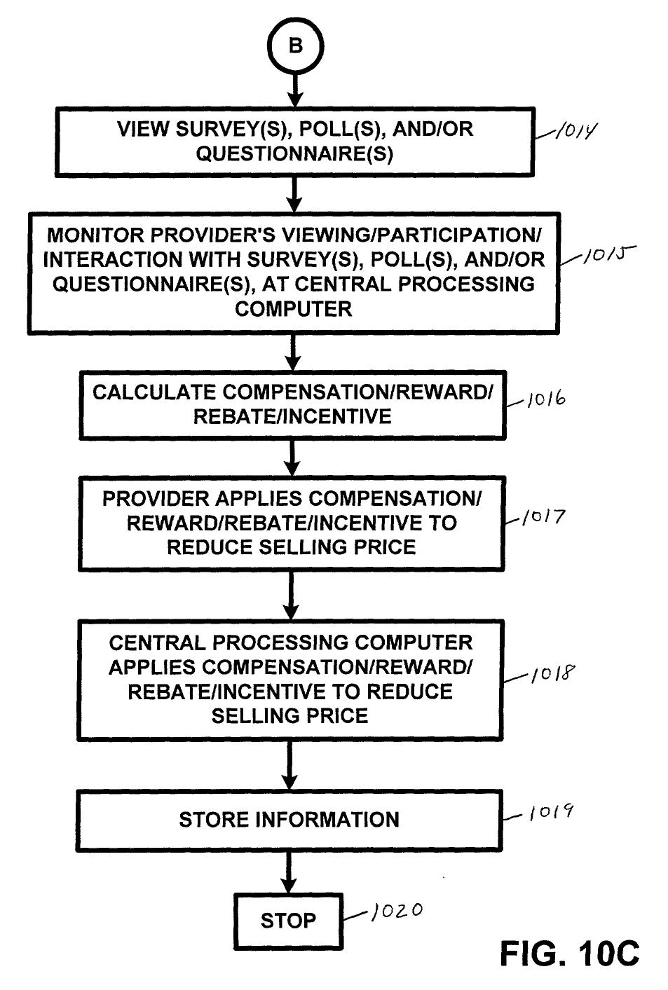

The apparatus and method of the present invention, in a preferred embodiment, can be utilized in order to provide a provider, seller, or lessor, (hereinafter referred to as “provider”) of goods, products, and/or services, with any one or more of compensation, rewards, rebates, and/or incentives, for viewing, reviewing, and/or participating in, surveys, polls, and/or questionnaires, of any type, nature or kind. FIGS. 10A, 10B, and 10C illustrate a method for utilizing the apparatus and method of the present invention, in flow diagram form.

With reference to FIG. 10, the operation of the apparatus and method of the present invention commences at step 1000. At step 1001, the provider can access the central processing computer 10 via the provider computer 30. At step 1002, the provider can provide information regarding the good(s), product(s), and/or service(s), which it is interested in selling and/or leasing. The information can include the name, description, price(s), warranty information, and/or any other information about the respective good(s), product(s), and/or service(s) provided for sale or lease by the provider. At step 1003, the provider can transmit its information regarding the good(s), product(s), and/or service(s), which it is interested in selling and/or leasing to the central processing computer 10.

At step 1004, the central processing computer 10 can receive the provider's information. At step 1005, the central processing computer 10 can process the provider's information regarding the respective goods, products, and/or services, from the database 10H. In another preferred embodiment, the central processing computer 10 can transmit a signal to, and receive any other or additional information from any of the respective user computer(s) 20, provider computers 30, advertiser computer(s) 40, and/or an information gathering entity computer 50.

Any of the provider computers 30 can provide or transmit information regarding any of the respective goods, products, and/or services, which are provided by the respective provider(s), to the central processing computer 10 at any time, at specified or random intervals, and/or in any other manner. The information provided by the providers or provider computers 30 can include any information related to the offering for sale of, the sale of, a description of, prices of, warranty information for, any of the goods, products, and/or services, provider by the provider. The information provided by the provider can also include any other information and/or data which may be related to the sale of and/or support of any of the goods, products, and/or services, provided by the apparatus and method of the present invention.

With reference once again to FIG. 10, the central processing computer 10 can also, at step 1005, identify an survey(s), poll(s), and/or questionnaire(s), which can be offered to the provider for the provider's viewing, participation and/or feedback.

The survey(s), poll(s), and/or questionnaire(s), can be selected from the database 10H, and/or can be provided from a respective information gathering entity computer 50 to the database 10H. In the preferred embodiment, the survey(s), poll(s), and/or questionnaire(s), can be stored in the database 10H. Information and/or data for selecting survey(s), poll(s), and/or questionnaire(s), in response to a posting of goods, products, and/or services, for sale or lease can also be stored in the database 10H.

The survey(s), poll(s), and/or questionnaire(s), can be selected based upon any relation and/or correlation of the survey(s), poll(s), and/or questionnaire(s), to the profile of the provider (which can be stored previously), by the nature of the provider's business and/or the goods, products, and/or services, which the provider offers for sale or lease as well as the goods, products, and/or services, which the provider may itself purchase or lease in the course of its business operations and/or other activities.

The survey(s), poll(s), and/or questionnaire(s), can also be selected based upon information regarding the provider's residence, citizenship, background, purchasing history, leasing history, income, profits, spending habits, spending patterns, buying habits, buying patterns, leasing habits, leasing patterns, previously purchased goods, products, and/or services, past responses to surveys, polls, and/or questionnaires, past compensation, rewards, rebates, and/or incentives, earned, and/or any other information and/or data which can be utilized in identifying surveys, polls, and/or questionnaires, to provide to the provider.

In another preferred embodiment, the central processing computer 10 can transmit a signal to the information gathering entity computer 50 notifying the information gathering entity computer 50 of the provider's posting of goods, products, and/or services, for sale or lease and/or the offering of the goods, products, and/or services, for sale or lease. The information gathering entity computer 50 can then select and transmit a desired survey(s), poll(s), and/or questionnaire(s), to the central processing computer 10 for later transmission to the provider computer 30.

At step 1006, the central processing computer 10 will transmit a message to the provider computer 30 of the provider. The message can contain the survey(s), poll(s), and/or questionnaire(s), identified by the central processing computer 10 along with the compensation, rewards, rebates, and/or incentives, associated and/or corresponding to each of survey(s), poll(s), and/or questionnaire(s). At step 1007, the provider can review the message and decide whether it desires to view, review, and/or participate in, the survey(s), poll(s), and/or questionnaire(s).

At step 1008, the provider computer 30 will transmit the provider's response to the central processing computer 10. The central processing computer 10 will, at step 1009, receive and process the provider's response. At step 1010, the central processing computer 10 will determine if the provider is interested in viewing, reviewing, and/or participating in, the survey(s), poll(s), and/or questionnaire(s). If, at step 1010, it is determined that the provider is not interested in receiving the survey(s), poll(s), and/or questionnaire(s), information, the central processing computer 10 will proceed to step 1011 and record and store the information regarding the posting of the goods, products, and/or services for sale or lease and the survey(s), poll(s), and/or questionnaire(s), offered to, and declined by, the provider.

The information recorded or stored, at step 1011, can be stored in the database 10H and can be accessed by any of the user computers 20, the provider computers 30, the advertiser computers 40, the information gathering entity computers 50, and/or any of the other central processing computers 10. Thereafter, the operation of the apparatus will cease at step 1012.

If, at step 1010, it is determined that the provider is interested in receiving the survey(s), poll(s), and/or questionnaire(s), information, the central processing computer 10 will proceed to step 1013 and will transmit the survey(s), poll(s), and/or questionnaire(s), and/or advertisements to the provider computer 30. At step 1014, the provider can view the survey(s), poll(s), and/or questionnaire(s), review the survey(s), poll(s), and/or questionnaire(s), and/or participate and/or interact, with the survey(s), poll(s), and/or questionnaire(s). The survey(s), poll(s), and/or questionnaire(s), provided to the provider can be text survey(s), poll(s), and/or questionnaire(s), graphical survey(s), poll(s), and/or questionnaire(s), video survey(s), poll(s), and/or questionnaire(s), audio survey(s), poll(s), and/or questionnaire(s), and/or audio-visual survey(s), poll(s), and/or questionnaire(s), and/or any combination of same. The survey(s), a poll(s), and/or a questionnaire(s) can also include or contain surveys, polls, questionnaires, and/or advertisements.

The survey(s), a poll(s), and/or questionnaire(s), can also include or contain multiple survey(s), a poll(s), and/or a questionnaire(s), and/or advertisements, for any type and/or number or combination of goods, products, services, and/or subject matter or issues. The survey(s), a poll(s), and/or a questionnaire(s), can include or contain any number of survey(s), a poll(s), and/or a questionnaire(s), and/or survey(s), a poll(s), and/or a questionnaire(s), relating to a plurality of subject areas and/or issues.

The survey(s), a poll(s), and/or a questionnaire(s), can be encoded, digitally encoded, numbered, page numbered, frame numbered, time marked, and/or otherwise marked, encoded, and/or numbered so as to monitor the amount of the survey(s), poll(s), and/or questionnaire(s), viewed or reviewed by the provider. The survey(s), poll(s), and/or questionnaire(s), can also include links, hyperlinks, questionnaires, dialog boxes, and/or any other interactive mechanism or means for allowing the provider to participate in and/or interact with the survey(s), poll(s), and/or questionnaire(s). At step 1014, any and/or all survey(s), poll(s), and/or questionnaire(s), can be provided to the provider.

At step 1015, the central processing computer 10 will monitor the provider's viewing, reviewing, and/or participation in and/or interaction with the survey(s), poll(s), and/or questionnaire(s). The provider can stop, cancel and/or delete, any survey(s), poll(s), and/or questionnaire(s). The provider can also replay and/or repeat any survey(s), poll(s), and/or questionnaire(s). Compensation, rewards, rebates, and/or incentives, can be provided for replaying and/or repeating survey(s), poll(s), and/or questionnaire(s), at the advertisers discretion. Any and/or all survey(s), poll(s), and/or questionnaire(s), can be monitored at step 1015.

The central processing computer 10 can monitor the provider's viewing, reviewing, participation in and/or interaction with, the survey(s), poll(s), and/or questionnaire(s), during step 1015 and/or at the completion of step 1015. The central processing computer 10 can also monitor provider activity in real-time, in a time-delayed manner, in a deferred manner, and/or in any other appropriate manner. Upon the completion of step 1015, the central processing computer 10 will proceed to step 1016.

At step 1016, the central processing computer 10 will calculate the compensation, reward(s), rebate(s), and/or incentive(s), earned by the provider at step 1014 and/or at step 1015. The compensation, reward, rebate, and/or incentive, can be determined by what the information gathering entity or information gathering entities has previously decided to provide to the provider for the viewing of, the reviewing of, the participation in and/or the interaction with, the survey(s), poll(s), and/or questionnaire(s).

Compensation, rewards, rebates, and/or incentives, can be provided for viewing, reviewing, participating in and/or interacting with, the entire survey(s), poll(s), and/or questionnaire(s), and/or any portions thereof. Compensation, rewards, rebates, and/or incentives, can be fixed in nature, variable in nature, and/or of a hybrid of a fixed and a variable nature. Compensation, rewards, rebates, and/or incentives, can be also be randomly determined by the central processing computer 10 and/or by the respective information gathering entity or information gathering entity computer 50.

As noted above, compensation, rewards, rebates, and/or incentives, can be determined in any appropriate manner, including, but not limited to, a fixed compensation amount for viewing, reviewing, participating in and/or interacting with the entire survey, poll, and/or questionnaire, a variable amount, a pro rata amount depending upon the amount of the survey, poll, and/or questionnaire, viewed, reviewed, participated in and/or interacted with, a fixed amount per segment of the survey, poll, and/or questionnaire, viewed, reviewed, participated in and/or interacted with, a variable amount per segment of the survey, poll, and/or questionnaire, viewed, reviewed, participated in and/or interacted with, and/or any other appropriate manner for providing compensation, rewards, rebates, and/or incentives pursuant to the present invention.

Compensation, rewards, rebates, and/or incentives, can also be determined on a case-by-case basis, on an information gathering basis, on a survey/poll/questionnaire-by-survey/poll/questionnaire basis, and/or can be determined by any other method such as, but not limited to, time-related factors, seasonal-related factors, economic environment-related factors, and/or any other suitable factors. At step 1016, the central processing computer 10 can determine the total compensation, reward, rebate, and/or incentives, earned by the provider.

At step 1017, the total compensation, reward, rebate, and/or incentive, earned by the provider can then be applied, by the provider, to reduce the selling or leasing price of the goods, products, and/or services, offered for sale or lease by the provider, to a provider spending account, and/or as a direct payment to the provider. In the preferred embodiment, the respective compensation, reward, rebate, and/or incentive, can take the form of a price reduction or savings which is applied directly to the selling or leasing price. In this manner, the respective compensation, reward, rebate, and/or incentive, results in a price reduction and/or savings which can be immediately utilized to enhance the provider's offering(s).

In another preferred embodiment, the provider can apply the respective compensation, reward, rebate, and/or incentive, towards a sweepstakes prize offered to its customers or potential customers. In another preferred embodiment, the respective compensation, reward, rebate, and/or incentive, can be applied by the provider to obtain a price reduction for any purchase or lease which it desires to make as a consumer. In another preferred embodiment, the respective compensation, reward, rebate, and/or incentive, can be applied to a savings account for later use by the provider to make purchases for itself and/or make price reductions for later offerings.

In another preferred embodiment, the provider can apportion the respective compensation, rewards, rebates, and/or incentives, among any one or more of the herein-described uses.

In another preferred embodiment, the respective compensation, reward, rebate, and/or incentive, can be utilized and/or applied to a contemporaneous purchase or lease by the provider and/or can be transferred to, and be utilized by, a third party individual or user designated by the provider. In another preferred embodiment, the respective compensation, reward, rebate, and/or incentive, can also be utilized wholly and/or in part.

In another preferred embodiment, the respective compensation, reward, rebate, and/or incentive, can be wholly or partly stored in an account set up for the provider with information and/or data regarding the account being maintained at the central processing computer 10 and/or the respective provider computer 30 and/or any of the other computers 10, 20, 40 and/or 50, described herein.

At step 1018, the central processing computer 10 will apply the respective compensation, rewards, rebates, and/or incentives in the manner directed by the provider. At step 1019, the central processing computer 10 will record and store the information regarding the posting of the goods, products, and/or services, for sale or lease and the survey(s), poll(s), and/or questionnaire(s), offered to, accepted by, and/or declined by, the provider. The information recorded or stored, at step 1019, can be stored in the database 10H and can be accessed by any of the user computers 20, the provider computers 30, the advertiser computers 40, the information gathering entity computers 50, and/or any of the other central processing computers 10.

At step 1019, any information regarding the provider, the goods, products, and/or services, which are the subject of the posting of offering, the survey(s), poll(s), and/or questionnaire(s), and/or advertisements, which the provider viewed, reviewed, participated in and/or interacted with, the respective compensation, reward, rebate, and/or incentive, earned, as well as how and in what manner and/or manners the respective compensation, rewards, rebates, and/or incentives, were utilized and/or applied, including reductions of the final selling prices or leasing prices, any direct or indirect use of the respective compensation, rewards, rebates, and/or incentives, and/or any transfer or storage of same, by the provider, are recorded and stored in the database 10H. Thereafter, the operation of the apparatus 100 will cease at step 1020.

In this manner, the apparatus and method of the present invention can provide for compensation, a reward, a rebate, and/or incentives, for viewing, reviewing, an/or participating in and/or interacting with, the survey(s), poll(s), and/or questionnaire(s), and/or advertisements, with the respective compensation, reward, rebate, and/or incentive, being applied reduce a selling price or leasing price, in an immediate, contemporaneous, simultaneous, and/or concurrent manner. The apparatus and method of the present invention can provide for an immediate application of compensation, a reward, a rebate, and/or an incentive, to a purchase price or lease price. The apparatus and method of the present invention can also provide for a deferred use or application of compensation, a reward, a rebate, and/or an incentive, to a selling price or leasing price for a non-contemporaneous or non-concurrent purchase or lease transaction.

In another preferred embodiment, the survey(s), poll(s), and/or questionnaire(s), can be the survey(s), poll(s), and/or questionnaire(s), for goods, products, services, political the survey(s), poll(s), and/or questionnaire(s), public service the survey(s), poll(s), and/or questionnaire(s), industry the survey(s), poll(s), and/or questionnaire(s), trade group the survey(s), poll(s), and/or questionnaire(s), and/or any other type of the survey(s), poll(s), and/or questionnaire(s).

In another preferred embodiment, the central processing computer 10 can determine the survey(s), poll(s), and/or questionnaire(s) to be offered and/or provided to the provider by utilizing profile information, market research information, statistical information, and/or historical information, stored in the database 10H and/or provided by any the individuals or users, providers, advertisers, and/or information gathering entities, and/or their respective computers 10, 20, 30, 40, and/or 50.

In another preferred embodiment, the compensation, rewards, rebates, and/or incentives, can take the form of direct price reductions, rebate checks, frequent flier rewards, financial rewards, digital money, coins, and/or tokens, coupons and/or electronic coupons for later purchases or leases of the same goods, products, and/or services, related goods, products, and/or services, and/or unrelated goods, products, and/or services.

In another preferred embodiment, the survey(s), poll(s), and/or questionnaire(s), can be provided to the provider, and the resulting compensation, rewards, rebates, and/or incentives, can be determined, prior to the provider making the decision to post or offer the good(s), product(s), and/or service(s) for sale or lease. In another preferred embodiment, the survey(s), poll(s), and/or questionnaire(s), can be provided to the provider prior to the provider making the decision to offer to sell or lease the good(s), product(s), and/or service(s), and the resulting compensation, rewards, rebates, and/or incentives, can be determined afterwards and prior to completing the posting or offering.

In any and/or all of the embodiments described herein any individual or entity can utilize the apparatus and method of the present invention in the role(s) or individual or user, buyer, lessee, seller, lessor, provider, advertiser, and/or information gathering entity. For example, a provider can utilize the present invention in order to sell goods, products, and/or services, to buy or lease goods, products, and/or services, to advertise goods, products, and/or services, and/or to conduct surveys regarding any appropriate topic or issue. Any of the other individuals and/or entities described herein can likewise utilize the present invention in multiple roles and/or modes of use.

In any and/or all of the embodiments described herein, the central processing computer can serve as a clearinghouse for selling, leasing, and/or buying any respective goods, products, and/or services.

In any and/or all of the embodiments, the central processing computer can administer and/or manage financial accounts for any of the respective parties described herein. The central processing computer 10 can also transfer money, funds, electronic money, and/or any other financial and/or monetary value for or on behalf of any of the parties involved in a transaction. For example, a advertiser or information gathering entity can deposit funds, or disseminating a respective advertisement or survey, into its respective account. As users earn compensation, rewards, rebates, and/or incentives, by viewing, reviewing, participation in, and/or interacting with, the respective advertisement or survey, the central processing computer can transmit the amount of the respective compensation, reward, rebate, or incentive, to the user's account thereby adding the amount to the user's account.

The central processing computer 10 can also deduct the amount form the advertiser's or information gathering entity's account. In this manner, the central processing computer 10 can perform any and/or all necessary and/or related accounting services in administering and managing the respective financial accounts.

In any and/or of the embodiments described herein, the central processing computer 10 can maintain and/or all financial records for any of the respective parties described herein.

The apparatus and/or the central processing computer can receive funds and/or financial equivalents, and/or promises for same, from the respective advertiser(s) and/or information gathering entity or entities along with instructions on how to disseminate the respective advertisement(s), survey(s), poll(s), and/or questionnaire(s), and/or the level(s) of compensation, reward, rebate, and/or incentive, to be provided to the individual(s) or user(s). The apparatus and/or the central processing computer can also be programmed so as to determine how to disseminate the respective advertisement(s) survey(s), poll(s), and/or questionnaire(s), and/or the level(s) of compensation, reward, rebate, and/or incentive, to be provided to the individual(s) or user(s).

The apparatus and/or the central processing computer can also be programmed so as to randomly determine, on behalf of the respective advertiser(s) and/or information gathering entity or entities, how to disseminate the respective advertisement(s), survey(s), poll(s), and/or questionnaire(s), and/or the level(s) of compensation, reward, rebate, and/or incentive, to be provided to the individual(s) or user(s). The apparatus and/or the central processing computer can also be programmed so as to run or conduct contests and/or sweepstakes for, and/or to disseminate prizes for, or on behalf of, the respective advertiser(s) and/or information gathering entity or entities.

In any and/or all of the embodiments described herein, the present invention can be utilized in conjunction with auctions and bidding operations and/or activities.

In any and/or all of the embodiments described herein, a user can search the database 10H of the central processing computer 10 in order to find advertisements and/or surveys, polls, and/or questionnaires, which they may be interested in viewing, reviewing, participating in and/or interacting with, in order to earn compensation, rewards, rebates, and/or incentives.

In any and/or all of the embodiments described herein, a user can also list requests, with any one or more of the central processing computer 10, a provider computer 30, an advertiser computer 40, and/or an information gathering entity computer 50, to be electronically notified, by telephone call, e-mail, beeper message, pager message, facsimile transmission, and/or via any other appropriate method or means, upon the posting or listing of advertisements and/or surveys, polls, and/or questionnaires, for or regarding, any goods, products, services, topics, issues, and/or subject matter, and/or having a certain level or amount of compensation, rewards, rebates, and/or incentives. Upon the posting or listing of the advertisement and/or the survey, poll, and/or questionnaire, the respective central processing computer 10, a provider computer 30, an advertiser computer 40, and/or an information gathering entity computer 50, can generate and transmit a notification message to the user computer 20 or other communication device.

In another preferred embodiment, the central processing computer 10 can receive requests and/or instructions from an individual or user requesting that the central processing computer 10 notify the individual or user upon the posting or listing of certain advertisements, surveys, polls, and/or questionnaires. Advertisements, surveys, polls, and/or questionnaires, can be posted, listed, and/or otherwise received, by the central processing computer 10 and can be stored in the database 10H of same. The central processing computer 10 can perform a query or search of the advertisements, surveys, polls, and/or questionnaires, upon the occurrence of a certain event or happening, such as, but not timed to, the receiving of a new advertisement(s), survey(s), poll(s), and/or questionnaire(s), the receiving of a new request from an individual or user, the passage of a certain time period, and/or any other search prompting occurrence, event, or happening.

The query or search can be performed by comparing individual requests against the advertisements, surveys, polls, and/or questionnaires, which are stored in the database 10H. If a match is detected, the central processing computer will generate a notification message and transmit same to the user computer or communication device 10. The notification message will contain information regarding the respective advertisement(s), survey(s), poll(s), and/or questionnaire(s), thereby providing notification to the individual or user that the respective advertisement(s), survey(s), poll(s), and/or questionnaire(s), are available for viewing and/or individual participation and/or interaction.

In any of the herein-described embodiments, the database 10H can also include data and/or information concerning transactions and/or transaction histories with such data and/or information stored after each transaction or attempted transaction. The data and/or information can then be compiled and processed using statistical calculations in order to update the stored historical transaction data and/or information. The stored data and/or information can then be made available to any of the individuals or entities described herein as utilizing the apparatus and method of the present invention.

Applicant hereby incorporates by reference herein the subject matter of Fundamentals of Database Systems, by Ramez Elmasri and Shamkant B. Navathe, 2^{nd} Ed., Addison-Wesley Publishing Company, 1994.

The present invention, in any and/or all of the herein-described embodiments, can utilize electronic commerce technologies and/or security methods, techniques and technologies, as described and set forth in Electronic Commerce Technical, Business, and Legal Issues, Nabil R. Adam, et al. Prentice Hall, 1999 and in Web Security & Commerce, Simson Garfinkel with Gene Spafford, O'Reilly 1997, the subject matter of which are also hereby incorporated by reference herein.

The apparatus and method of the present invention can be utilized to provide service anywhere in the world.

In another preferred embodiment, the present invention can be utilized in conjunction with intelligent agents, software agents, and/or mobile agents. In such embodiments, the agent can be programmed to perform any and all operations, transactions, and/or functions, described herein, and/or to automate any of the operations described herein, for or on behalf of any of the respective individuals or entities described herein are utilizing the apparatus and method of the present invention. Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

Any of the individual, users, providers, advertisers, and/or information gathering entities, who or which utilize the present invention, can be subscribers to the services described herein and/or offered thereby. In this manner, a network of subscribers can be established and can be utilized in future commerce activities. Non-subscribers may also utilize the present invention.

In any of the embodiments described herein, any communications between any of the respective individuals or entities can be facilitated by utilizing any suitable communication method, means, or mechanism.

The apparatus and method of the present invention can also be utilized by both selling and buying parties at the same time in order to allow both parties to a transaction to receive the benefits provided by the present invention.

In any and/or all of the embodiments described herein, the advertisers and/or the information gathering entities can deploy or launch their respective advertisements and/or surveys by transmitting same via their respective advertiser computers 40 and information gathering entity computers 50 to the central processing computer(s) 10.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. An apparatus for providing compensation for viewing and/or for participating in an advertisement, comprising:
a receiver for receiving a request to obtain information regarding at least one of a good, a product, and a service;
a memory device for storing information regarding at least one of the at least one of a good, a product, and a service, advertisement information, and at least one advertisement;
a processor for processing said request to receive information regarding the at least one of a good, a product, and a service, wherein said processor at least one of identifies and selects an advertisement to provide to the information requesting individual upon the information requesting individual placing an order to at least one of purchase and lease at least one of a good, a product, and a service; and
a transmitter for transmitting said advertisement to a communication device associated with the information requesting individual;
wherein said processor at least one of monitors the requesting individual's at least one of viewing and participation in the advertisement, and further wherein said processor determines an amount of at least one of a compensation, a reward, a rebate, and an incentive, earned by the information requesting individual, and further wherein said processor at least one of adjusts and reduces the at least one of a purchase price and a lease price associated with the order by at least a portion of the amount of said at least one of a compensation, a reward, a rebate, and an incentive.

2. The apparatus of claim 1, wherein the at least one of a purchase price and a lease price is at least one of adjusted and reduced by the entire amount of said at least one of a compensation, a reward, a rebate, and an incentive.

3. The apparatus of claim 1, wherein said processor at least one of identifies and selects the advertisement based upon at least one of profile information, individual profile information, at least one of good, product, and service information, market research information, statistical information, and historical information.

4. The apparatus of claim 1, wherein said advertisement is at least one of a text advertisement, a graphical advertisement, a video advertisement, an audio advertisement, an audio-visual advertisement, an infomercial, and a multimedia advertisement.

5. The apparatus of claim 1, wherein said advertisement at least one of includes and is accompanied by at least one of a survey, a poll, and a questionnaire.

6. The apparatus of claim 1, wherein the communication device is at least one of a personal computer, a hand-held computer, a palmtop computer, a laptop computer, a personal communication device, a personal digital assistant, a telephone, a wireless telephone, a digital telephone, a third generation (3G) telephone, a video telephone, a videophone, a television, an interactive television, a beeper, a pager, and/or a watch.

7. The apparatus of claim 1, wherein the amount of said at least one of a compensation, a reward, a rebate, and an incentive, is at least one of a fixed amount, a variable amount, a random amount, a pro rata amount, and a combination of a fixed amount, a variable amount, a random amount, and a pro rata amount.

8. The apparatus of claim 1, wherein said advertisement is at least one of an advertisement for at least one of a good, a product, and a service, a political advertisement, a public service advertisement, an industry advertisement, and a trade group advertisement.

9. The apparatus of claim 1, wherein said at least one of a compensation, a reward, a rebate, and an incentive, is at least one of a direct price reduction, a rebate check, a frequent flier reward, a financial reward, digital money, a digital coin, a token, a coupon, and an electronic coupon.

10. The apparatus of claim 1, wherein said at least one of a compensation, a reward, a rebate, and an incentive, can be earned at least one of prior to placing the order, during placing the order, and after placing the order.

11. An apparatus for providing compensation for viewing and/or for participating in an advertisement, comprising:
a transmitter for transmitting a request to obtain information regarding at least one of a good, a product, and a service;
a receiver for receiving information regarding at least one of a good, a product, and a service;
a processor for processing said information; and
a display device for displaying said information;
wherein said receiver receives an advertisement, and further wherein information regarding at least one of an individual's viewing of the advertisement, the individual's participation in the advertisement, and the individual's interaction with the advertisement, is transmitted by said transmitter to a central processing computer, and further wherein said central processing computer at least one of determines and computes at least one of a compensation, a reward, a rebate, and an incentive, associated with the at least one of the individual's viewing of the advertisement, the individual's participation in the advertisement, and the individual's interaction with the advertisement.

12. The apparatus of claim 11, wherein at least one of a purchase price and a lease price is at least one of adjusted and reduced by the entire amount of said at least one of a compensation, a reward, a rebate, and an incentive.

13. The apparatus of claim 11, wherein said advertisement is at least one of identified and selected based upon at least one of profile information, individual profile information, at least one of good, product, and service information, market research information, statistical information, and historical information.

14. The apparatus of claim 11, wherein said advertisement is at least one of a text advertisement, a graphical advertisement, a video advertisement, an audio advertisement, an audio-visual advertisement, an infomercial, and a multimedia advertisement.

15. The apparatus of claim 11, wherein said advertisement at least one of includes and is accompanied by at least one of a survey, a poll, and a questionnaire.

16. The apparatus of claim 11, wherein the communication device is at least one of a personal computer, a hand-held computer, a palmtop computer, a laptop computer, a personal communication device, a personal digital assistant, a telephone, a wireless telephone, a digital telephone, a third generation (3G) telephone, a video telephone, a videophone, a television, an interactive television, a beeper, a pager, and/or a watch.

17. The apparatus of claim 11, wherein the amount of said at least one of a compensation, a reward, a rebate, and an incentive, is at least one of a fixed amount, a variable amount, a random amount, a pro rata amount, and a combination of a fixed amount, a variable amount, a random amount, and a pro rata amount.

18. The apparatus of claim 11, wherein said advertisement is at least one of an advertisement for at least one of a good, a product, and a service, a political advertisement, a public service advertisement, an industry advertisement, and a trade group advertisement.

19. The apparatus of claim 11, wherein said at least one of a compensation, a reward, a rebate, and an incentive, is at least one of a direct price reduction, a rebate check, a frequent flier reward, a financial reward, digital money, a digital coin, a token, a coupon, and an electronic coupon.

20. A method for providing compensation for viewing and/or for participating in an advertisement, comprising:
receiving a request to obtain information regarding at least one of a good, a product, and a service;
storing information regarding at least one of the at least one of a good, a product, and a service, advertisement information, and at least one advertisement;
processing said request to receive information regarding the at least one of a good, a product, and a service;
at least one of identifying and selecting an advertisement to provide to the information requesting individual upon the information requesting individual placing an order to at least one of purchase and lease at least one of a good, a product, and a service;
transmitting said advertisement to a communication device associated with the information requesting individual;
at least one of monitoring the requesting individual's at least one of viewing of and participation in the advertisement;
determining an amount of at least one of a compensation, a reward, a rebate, and an incentive, earned by the information requesting individual; and
at least one of adjusting and reducing the at least one of a purchase price and a lease price associated with the order by at least a portion of the amount of said at least one of a compensation, a reward, a rebate, and an incentive.
